(19) United States
(12) Patent Application Publication
(10) Pub. No.: US 2024/0276516 A1
(43) Pub. Date: Aug. 15, 2024

(54) CAPABILITY TO PROCESS CONTROL INFORMATION PER CONTROL RESOURCE SET POOL INDEX

(71) Applicant: QUALCOMM Incorporated, San Diego, CA (US)

(72) Inventors: Mostafa KHOSHNEVISAN, San Diego, CA (US); Peter GAAL, San Diego, CA (US); Xiaoxia ZHANG, San Diego, CA (US); Jing SUN, San Diego, CA (US)

(21) Appl. No.: 18/415,515

(22) Filed: Jan. 17, 2024

Related U.S. Application Data
(60) Provisional application No. 63/484,921, filed on Feb. 14, 2023.

(51) Int. Cl. H04W 72/232; H04L 5/00; H04W 72/1263

(52) U.S. Cl. CPC H04W 72/232; H04L 5/0053; H04W 72/1263

(57) ABSTRACT

Methods, systems, and devices for wireless communications are described. A user equipment (UE) may transmit a capability message indicating a threshold quantity of downlink control information (DCI) messages the UE is capable of processing in a time duration for each component carrier (CC) that is associated with multiple control resource set (CORSET) pool index (e.g., CORESETPoolIndex) values. The UE may receive a first control message (e.g., a radio resource control (RRC) configuration message) indicating a configuration that enables the UE to process the threshold quantity of DCI messages. The UE may receive a second control message indicating that a CC is configured with the multiple of CORESETPoolIndex values. The UE may receive one or more DCI messages associated with the CC based on the threshold quantity of DCI messages and the CC being configured with the multiple CORESETPoolIndex values.

### CROSS REFERENCE

The present Application for Patent claims the benefit of U.S. Provisional Patent Application No. 63/484,921 by Khoshnevisan et al., entitled “CAPABILITY TO PROCESS CONTROL INFORMATION PER CONTROL RESOURCE SET POOL INDEX,” filed Feb. 14, 2023, assigned to the assignee hereof, and which is expressly incorporated by reference herein.

### FIELD OF TECHNOLOGY

The following relates to wireless communications, including capabilities to process control information per control resource set (CORESET) pool index.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support one or more capabilities to process control information per control resource set (CORESET) pool index. For example, the described techniques enable enhanced processing of multiple sets downlink control information (DCI) from multiple transmission and reception points (TRPs) based on a user equipment (UE) indicating a capability for processing DCIs for multi-TRP (mTRP) operation. For example, the UE may transmit a capability message indicating a threshold quantity of DCIs the UE is capable of processing in a time duration for respective component carriers (CCs) that are associated with multiple (e.g., two) CORESET pool index (e.g., CORESETPoolIndex) values. The capability message may indicate the threshold quantity of DCIs per CORESETPoolIndex value or across both CORESETPoolIndex values. In some examples, the UE may indicate a first capability associated with a threshold quantity of DCIs for downlink and a second capability associated with a threshold quantity of DCIs for uplink. In some examples, the UE may receive a radio resource control (RRC) configuration enabling the UE to process the uplink and downlink DCIs for a scheduled CC associated with two CORESETPoolIndex values, which may be based on the capability signaling from the UE.

A method for wireless communications is described. The method may include transmitting a capability message indicating a threshold quantity of DCI messages the UE is capable of processing in a time duration for each CC that is associated with a set of multiple CORESET pool index values, receiving a first control message indicating that a CC is configured with the set of multiple CORESET pool index values, and receiving one or more DCI messages associated with the CC based on the threshold quantity of DCI messages and the CC being configured with the set of multiple CORESET pool index values.

A UE for wireless communications is described. The UE may include one or more memories storing processor executable code, and one or more processors coupled with the one or more memories. The one or more processors may be operable to execute the code to cause the UE to transmit a capability message indicating a threshold quantity of DCI messages the UE is capable of processing in a time duration for each CC that is associated with a set of multiple CORESET pool index values, receive a first control message indicating that a CC is configured with the set of multiple CORESET pool index values, and receive one or more DCI messages associated with the CC based on the threshold quantity of DCI messages and the CC being configured with the set of multiple CORESET pool index values.

Another UE for wireless communications is described. The UE may include means for transmitting a capability message indicating a threshold quantity of DCI messages the UE is capable of processing in a time duration for each CC that is associated with a set of multiple CORESET pool index values, means for receiving a first control message indicating that a CC is configured with the set of multiple CORESET pool index values, and means for receiving one or more DCI messages associated with the CC based on the threshold quantity of DCI messages and the CC being configured with the set of multiple CORESET pool index values.

A non-transitory computer-readable medium storing code for wireless communications is described. The code may include instructions executable by one or more processors to transmit a capability message indicating a threshold quantity of DCI messages the UE is capable of processing in a time duration for each CC that is associated with a set of multiple CORESET pool index values, receive a first control message indicating that a CC is configured with the set of multiple CORESET pool index values, and receive one or more DCI messages associated with the CC based on the threshold quantity of DCI messages and the CC being configured with the set of multiple CORESET pool index values.

Some examples of the method, UEs, and non-transitory computer-readable medium described herein may further include operations, features, means, or instructions for receiving a second control message indicating a control information configuration that enables the UE to process the threshold quantity of DCI messages for each CC that may be associated with the set of multiple CORESET pool index values, the control information configuration being based on the capability message, where receiving the one or more DCI messages may be based on receiving the second control message.

In some examples of the method, UEs, and non-transitory computer-readable medium described herein, the control information configuration enables the UE to process DCI messages for a first CC, or a bandwidth part (BWP), or both, associated with the set of multiple CORESET pool index values.

In some examples of the method, UEs, and non-transitory computer-readable medium described herein, the first CC, or the BWP, or both, includes a scheduling CC including first control information that schedules an uplink transmission or a downlink transmission for a second CC different from the scheduling CC and the first CC, or the BWP, or both, includes a scheduled CC including the downlink transmission or the uplink transmission scheduled by second control information received via a third CC different from the scheduled CC.

In some examples of the method, UEs, and non-transitory computer-readable medium described herein, the control information configuration enables for the UE to process DCI messages for each CC of a set of CCs that may be included in a cell group and associated with the set of multiple CORESET pool index values.

Some examples of the method, UEs, and non-transitory computer-readable medium described herein may further include operations, features, means, or instructions for indicating, via the capability message, that the threshold quantity of DCI messages may be for each of CORESET pool index value of the set of multiple CORESET pool index values.

Some examples of the method, UEs, and non-transitory computer-readable medium described herein may further include operations, features, means, or instructions for indicating, via the capability message, that the threshold quantity of DCI messages may be across the set of multiple CORESET pool index values.

Some examples of the method, UEs, and non-transitory computer-readable medium described herein may further include operations, features, means, or instructions for indicating, via the capability message, that the threshold quantity of DCI messages may be equal to a second threshold quantity of DCI messages the UE may be capable of processing for CCs that may be associated with a single CORESET pool index value or for CCs that may be not associated with a CORESET pool index value, where the threshold quantity of DCI messages may be for each of CORESET pool index value of the set of multiple CORESET pool index values.

Some examples of the method, UEs, and non-transitory computer-readable medium described herein may further include operations, features, means, or instructions for indicating, via the capability message, that the threshold quantity of DCI messages may be double a second threshold quantity of DCI messages the UE may be capable of processing for CCs that may be associated with a single CORESET pool index value or for CCs that may be not associated with a CORESET pool index value.

In some examples of the method, UEs, and non-transitory computer-readable medium described herein, the threshold quantity of DCI messages includes a first threshold quantity of DCI messages the UE may be capable of processing for downlink communications and a second threshold quantity of DCI messages the UE may be capable of processing for uplink communications.

In some examples of the method, UEs, and non-transitory computer-readable medium described herein, transmitting the capability message may include operations, features, means, or instructions for transmitting, as part of the capability message, respective threshold quantities of DCI messages each associated with respective monitoring configurations.

In some examples of the method, UEs, and non-transitory computer-readable medium described herein, the respective monitoring configurations include one or more of a slot-based downlink control channel monitoring, a span-based downlink control channel monitoring, a first cross-carrier scheduling scheme associated with a switch from a lower sub-carrier spacing (SCS) to a higher SCS, and a second cross-carrier scheduling scheme associated with a switch from the higher SCS to the lower SCS.

In some examples of the method, UEs, and non-transitory computer-readable medium described herein, the capability message may be associated with a band combination, a band, a band of a band combination, a CC of a band of a band combination, or a combination thereof.

In some examples of the method, UEs, and non-transitory computer-readable medium described herein, a first TRP may be associated with a first CORESET pool index value of the set of multiple CORESET pool index values and a second TRP may be associated with a second CORESET pool index value of the set of multiple CORESET pool index values and the one or more DCI messages may be received via the first TRP, the second TRP, or both.

In some examples of the method, UEs, and non-transitory computer-readable medium described herein, the time duration may be a slot, a physical downlink control channel (PDCCH) span, or a PDCCH monitoring occasion.

A method for wireless communications is described. The method may include receiving, from a UE, a capability message indicating a threshold quantity of DCI messages the UE is capable of processing in a time duration for each CC that is associated with a set of multiple CORESET pool index values, transmitting a first control message indicating that a CC is configured with the set of multiple CORESET pool index values, and transmitting one or more DCI messages associated with the CC based on the threshold quantity of DCI messages and the CC being configured with the set of multiple CORESET pool index values.

A network entity for wireless communications is described. The network entity may include one or more memories storing processor executable code, and one or more processors coupled with the one or more memories. The one or more processors may be operable to execute the code to cause the network entity to receive, from a UE, a capability message indicating a threshold quantity of DCI messages the UE is capable of processing in a time duration for each CC that is associated with a set of multiple CORESET pool index values, transmit a first control message indicating that a CC is configured with the set of multiple CORESET pool index values, and transmit one or more DCI messages associated with the CC based on the threshold quantity of DCI messages and the CC being configured with the set of multiple CORESET pool index values.

Another network entity for wireless communications is described. The network entity may include means for receiving, from a UE, a capability message indicating a threshold quantity of DCI messages the UE is capable of processing in a time duration for each CC that is associated with a set of multiple CORESET pool index values, means for transmitting a first control message indicating that a CC is configured with the set of multiple CORESET pool index values, and means for transmitting one or more DCI messages associated with the CC based on the threshold quantity of DCI messages and the CC being configured with the set of multiple CORESET pool index values.

A non-transitory computer-readable medium storing code for wireless communications is described. The code may include instructions executable by one or more processors to receive, from a UE, a capability message indicating a threshold quantity of DCI messages the UE is capable of processing in a time duration for each CC that is associated with a set of multiple CORESET pool index values, transmit a first control message indicating that a CC is configured with the set of multiple CORESET pool index values, and transmit one or more DCI messages associated with the CC based on the threshold quantity of DCI messages and the CC being configured with the set of multiple CORESET pool index values.

Some examples of the method, network entities, and non-transitory computer-readable medium described herein may further include operations, features, means, or instructions for transmitting a second control message indicating a control information configuration that enables the UE to process the threshold quantity of DCI messages for each CC that may be associated with the set of multiple CORESET pool index values, the control information configuration being based on the capability message, where transmitting the one or more DCI messages may be based on transmitting the second control message.

In some examples of the method, network entities, and non-transitory computer-readable medium described herein, the control information configuration enables the UE to process DCI messages for a first CC, or a BWP, or both, associated with the set of multiple CORESET pool index values.

In some examples of the method, network entities, and non-transitory computer-readable medium described herein, the first CC, or the BWP, or both, includes a scheduling CC including first control information that schedules an uplink transmission or a downlink transmission for a second CC different from the scheduling CC and the first CC, or the BWP, or both, includes a scheduled CC including the downlink transmission or the uplink transmission scheduled by second control information received via a third CC different from the scheduled CC.

In some examples of the method, network entities, and non-transitory computer-readable medium described herein, the control information configuration enables for the UE to process DCI messages for each CC of a set of CCs that may be included in a cell group and associated with the set of multiple CORESET pool index values.

Some examples of the method, network entities, and non-transitory computer-readable medium described herein may further include operations, features, means, or instructions for receiving, via the capability message, an indication that the threshold quantity of DCI messages may be for each of CORESET pool index value of the set of multiple CORESET pool index values.

Some examples of the method, network entities, and non-transitory computer-readable medium described herein may further include operations, features, means, or instructions for receiving, via the capability message, an indication that the threshold quantity of DCI messages may be across the set of multiple CORESET pool index values.

Some examples of the method, network entities, and non-transitory computer-readable medium described herein may further include operations, features, means, or instructions for receiving, via the capability message, an indication that the threshold quantity of DCI messages may be equal to a second threshold quantity of DCI messages the UE may be capable of processing for CCs that may be associated with a single CORESET pool index value or for CCs that may be not associated with a CORESET pool index value, where the threshold quantity of DCI messages may be for each of CORESET pool index value of the set of multiple CORESET pool index values.

Some examples of the method, network entities, and non-transitory computer-readable medium described herein may further include operations, features, means, or instructions for receiving, via the capability message, an indication that the threshold quantity of DCI messages may be double a second threshold quantity of DCI messages the UE may be capable of processing for CCs that may be associated with a single CORESET pool index value or for CCs that may be not associated with a CORESET pool index value.

In some examples of the method, network entities, and non-transitory computer-readable medium described herein, the threshold quantity of DCI messages includes a first threshold quantity of DCI messages the UE may be capable of processing for downlink communications and a second threshold quantity of DCI messages the UE may be capable of processing for uplink communications.

In some examples of the method, network entities, and non-transitory computer-readable medium described herein, receiving the capability message may include operations, features, means, or instructions for receiving, as part of the capability message, respective threshold quantities of DCI messages each associated with respective monitoring configurations.

In some examples of the method, network entities, and non-transitory computer-readable medium described herein, the respective monitoring configurations include one or more of a slot-based downlink control channel monitoring, a span-based downlink control channel monitoring, a first cross-carrier scheduling scheme associated with a switch from a lower SCS to a higher SCS, and a second cross-carrier scheduling scheme associated with a switch from the higher SCS to the lower SCS.

In some examples of the method, network entities, and non-transitory computer-readable medium described herein, the capability message may be associated with a band combination, a band, a band of a band combination, a CC of a band of a band combination, or a combination thereof.

In some examples of the method, network entities, and non-transitory computer-readable medium described herein, a first TRP of the network entity may be associated with a first CORESET pool index value of the set of multiple CORESET pool index values and a second TRP of the network entity may be associated with a second CORESET pool index value of the set of multiple CORESET pool index values and the one or more DCI messages may be transmitted via the first TRP, the second TRP, or both.

In some examples of the method, network entities, and non-transitory computer-readable medium described herein, the time duration may be a slot, a PDCCH span, or a PDCCH monitoring occasion.

### BRIEF DESCRIPTION OF THE DRAWINGS

FIG. 1 illustrates an example of a wireless communications system that supports capabilities to process control information per control resource set (CORESET) pool index in accordance with one or more aspects of the present disclosure.

FIG. 2 illustrates an example of a wireless communications system that supports capabilities to process control information per CORESET pool index in accordance with one or more aspects of the present disclosure.

FIG. 3 illustrates an example of a process flow that supports capabilities to process control information per CORESET pool index in accordance with one or more aspects of the present disclosure.

FIGS. 4 and 5 illustrate block diagrams of devices that support capabilities to process control information per CORESET pool index in accordance with one or more aspects of the present disclosure.

FIG. 6 illustrates a block diagram of a communications manager that supports capabilities to process control information per CORESET pool index in accordance with one or more aspects of the present disclosure.

FIG. 7 illustrates a diagram of a system including a device that supports capabilities to process control information per CORESET pool index in accordance with one or more aspects of the present disclosure.

FIGS. 8 and 9 illustrate block diagrams of devices that support capabilities to process control information per CORESET pool index in accordance with one or more aspects of the present disclosure.

FIG. 10 illustrates a block diagram of a communications manager that supports capabilities to process control information per CORESET pool index in accordance with one or more aspects of the present disclosure.

FIG. 11 illustrates a diagram of a system including a device that supports capabilities to process control information per CORESET pool index in accordance with one or more aspects of the present disclosure.

FIGS. 12 through 15 illustrate flowcharts showing methods that support capabilities to process control information per CORESET pool index in accordance with one or more aspects of the present disclosure.

### DETAILED DESCRIPTION

In some wireless communications systems, a user equipment (UE) capability may indicate a quantity of downlink control information (DCI) that a UE may process from a network entity during a time duration. As one example, for a frequency division duplexing (FDD) mode, a UE may have a capability to process two DCIs per slot (e.g., one unicast DCI scheduling downlink per slot and one unicast DCI scheduling uplink per slot). In another example, for a time division duplexing (TDD) mode, the UE may have a capability to process three DCIs per slot (e.g., one unicast DCI scheduling downlink per slot and two unicast DCI scheduling uplink per slot). Other capabilities of a UE may be possible, for example, for processing different quantities of DCI per various time intervals (e.g., per slot, per physical downlink control channel (PDCCH) monitoring occasion, per PDCCH span per slot, or the like).

In some examples, the UE may operate in accordance with multicast communications with the network entity. For example, the UE may concurrently communicate with multiple transmission and reception points (TRPs) associated with one or more network entities. In such examples, each TRP may be associated with a respective value of a control resource set (CORESET) pool index (e.g., CORESETPoolIndex), where each value may be associated with a respective set of CORESET IDs. That is, multi-TRP (mTRP) operation may be defined in a given component carrier (CC) by configuring two CORESETPoolIndex values in different CORESETs in the active bandwidth part (BWP) of the CC. The multiple CORESETPoolIndex values may increase the quantity of uplink and downlink messages the UE may communicate (e.g., concurrent communication of uplink or downlink messages via respective TRPs). The UE, however, may be limited to processing the quantity of DCIs scheduling such communications in accordance with single-TRP (sTRP) operation (e.g., based on conventional capabilities for DCI processing associated with sTRP operation). As such, the UE may be unable to utilize the performance increase associated with mTRP schemes if the UE processes DCI, for example, in accordance with sTRP operations.

The UE may increase performance of multi-DCI for mTRP by transmitting a capability regarding processing DCI for mTRP operation. For example, the UE may transmit a capability message indicating a threshold quantity of DCIs the UE is capable of processing in a time duration for each CC that is associated with multiple (e.g., two) CORESETPoolIndex values. The capability message may indicate the threshold quantity of DCIs per CORESETPoolIndex value or across both CORESETPoolIndex values. In some examples, the UE may indicate a first capability associated with a threshold quantity of DCIs for downlink and a second capability associated with a threshold quantity of DCIs for uplink. In some examples, the UE may receive a radio resource control (RRC) configuration enabling the UE to process the uplink and downlink DCIs for a scheduled CC associated with two CORESETPoolIndex values.

Aspects of the disclosure are initially described in the context of wireless communications systems and a process flow. Aspects of the disclosure are further illustrated by and described with reference to apparatus diagrams, system diagrams, and flowcharts that relate to capability to process control information per CORESET pool index.

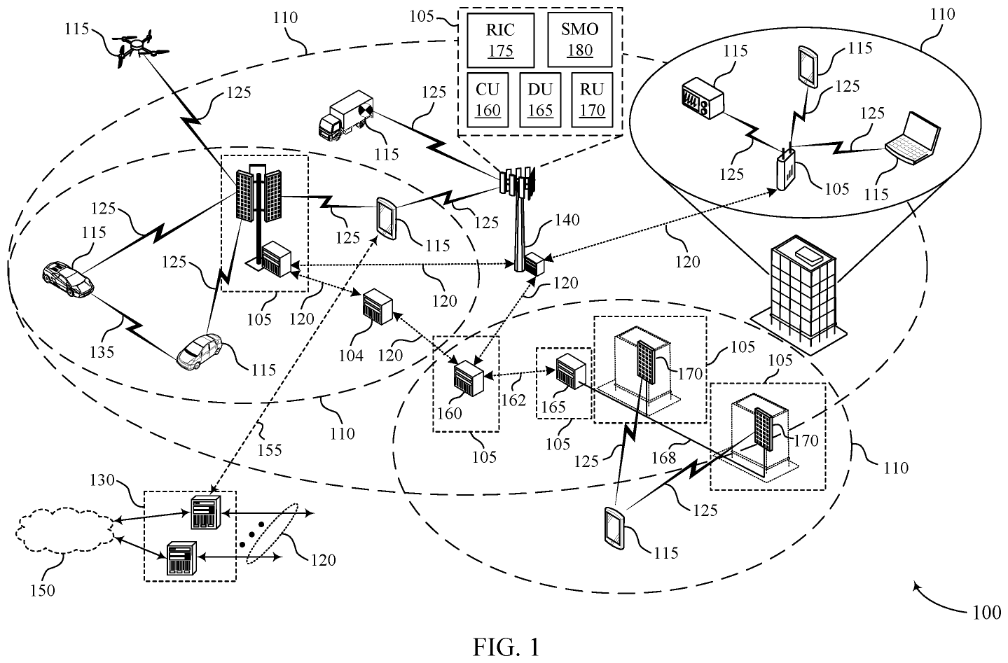

FIG. 1 illustrates an example of a wireless communications system 100 that supports capabilities to process control information per CORESET pool index in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support capability to process control information per CORESET pool index as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink CCs and one or more uplink CCs according to a carrier aggregation configuration. Carrier aggregation may be used with both FDD and time division duplexing (TDD) CCs. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum, and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a CORESET) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with CCs operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples of wireless communications system 100, a UE capability may indicate a quantity of DCI (e.g., DCI messages) a UE 115 may process from a network entity 105 during a time duration. For example, for a FDD mode, a UE 115 may support capabilities to process two DCIs per slot (e.g., one unicast DCI scheduling downlink and one unicast DCI scheduling uplink). In some examples, the UE 115 may operate in accordance with multicast communications with the network entity 105. For example, the UE 115 may concurrently communicate with multiple TRPs of one or more network entities 105. In such examples, each TRP may be associated with a respective value of a CORESETPoolIndex value, where each value may be associated with a respective set of CORESET IDs. That is, mTRP operation may be defined in a given CC by configuring two CORESETPoolIndex values in different CORESETs in the active BWP of the CC. The multiple CORESETPoolIndex values may increase the quantity of uplink and downlink messages the UE 115 may communicate (e.g., concurrent communication of messages via respective TRPs). However, the UE 115 may only be configured to process the quantity of DCIs scheduling such communications in accordance with sTRP operation. As such, the UE 115 may be unable to fully utilize the performance increase associated with mTRP operation if the UE 115 processes DCI, for example, in accordance with sTRP operations.

The wireless communications system 100 may enable increased performance of multi-DCI for mTRP communications by supporting enhanced capabilities for processing DCI for mTRP operation. For example, the UE 115 may transmit a capability message indicating a threshold quantity of DCIs the UE 115 is capable of processing for CCs that are associated with multiple (e.g., two or more) CORESETPoolIndex values. The capability message may indicate the threshold quantity of DCIs per CORESETPoolIndex value or the threshold quantity of DCIs across both CORESETPoolIndex values. In some examples, the UE 115 may indicate a first capability associated with a threshold quantity of DCIs for downlink and a second capability associated with a threshold quantity of DCIs for uplink. In some examples, the UE 115 may receive an RRC configuration enabling the UE 115 to process the uplink and downlink DCIs for a scheduled CC associated with two CORESETPoolIndex values.

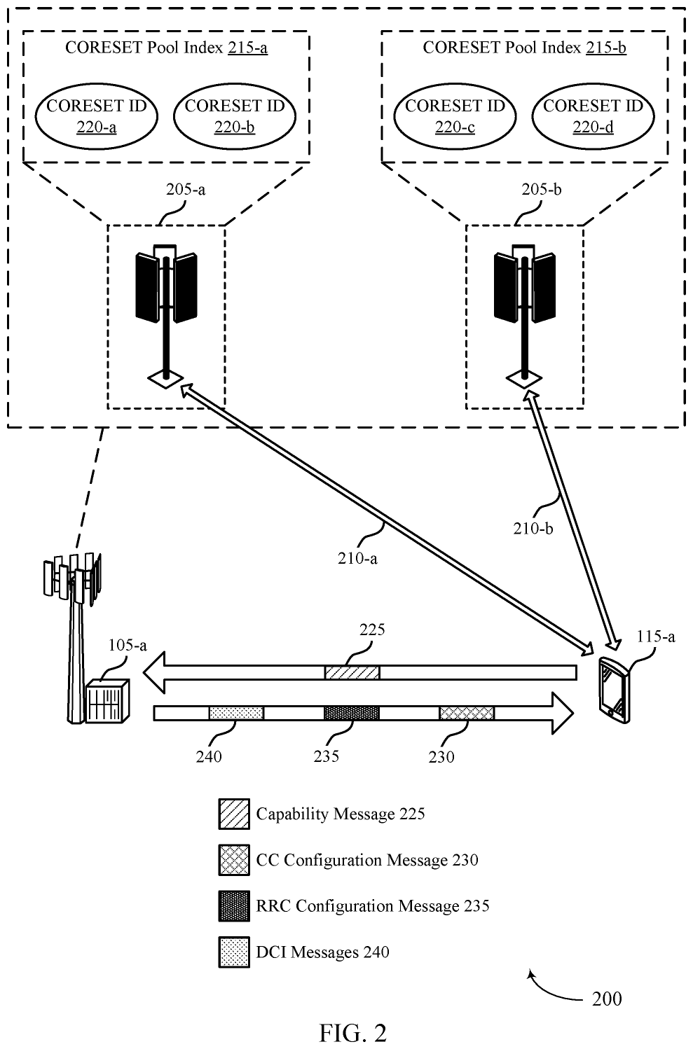

FIG. 2 illustrates an example of a wireless communications system 200 that supports capabilities to process control information per CORESET pool index in accordance with one or more aspects of the present disclosure. In some examples, the wireless communications system 200 may implement or be implemented by aspects of the wireless communications system 100. For example, the wireless communications system 200 may be implemented by one or more network entities 105 (e.g., network entity 105-a, one or more additional network entities 105, or a combination thereof) and one or more UEs 115 (e.g., UE 115-a), which may be examples of the corresponding devices as described herein with reference to FIG. 1. In the example of FIG. 2, the network entity 105-a and the one or more additional network entities 105 may be an example of a CU 160, a DU 165, an RU 170, a base station 140, an IAB node 104, or one or more other network nodes as described herein with reference to FIG. 1. In some aspects, the UE 115-a may communicate capability information associated with a threshold quantity of DCI messages (e.g., DCI scheduling uplink transmissions, DCI scheduling downlink transmissions, or both) that the UE 115-a may be capable of processing during mTRP operations.

Based on various communication modes, the UE 115-a may support capabilities for processing DCIs (e.g., DCI messages) for a given CC. For example, with reference to sTRP communications with the network entity 105-a, the UE 115-a may be able to process various quantities of DCIs based on various monitoring configurations or various PDCCH monitoring capabilities. For example, as a baseline capability (e.g., associated with a particular feature group (e.g., feature group 3-1)) in a FDD mode, the UE 115-a may process one unicast DCI scheduling downlink per slot and process one unicast DCI scheduling uplink per slot. In a TDD mode, the UE 115-a may process one unicast DCI scheduling downlink per slot and process two unicast DCIs scheduling uplink per slot.

Additionally, or alternatively, the UE 115-a may support processing one or more DCIs for monitoring configurations different than a per slot basis. For example, in a single PDCCH monitoring occasion (PMO), the UE 115-a may support processing of one unicast DCI scheduling downlink and processing of one unicast DCI scheduling uplink, where there may be multiple PMOs per slot (e.g., up to four PMOs for a 30 kHz sub-carrier spacing (SCS)), which may correspond to a different (e.g., optional) feature group (e.g., feature group 3-5a). A feature group may correspond to one or more features supported by a UE 115, and each feature group may be associated with an index value or a UE capability reporting parameter. As an example, a feature of downlink control channel and procedure may include a first feature group (e.g., basic downlink control channel) associated with an index value of 3-1 and having various components corresponding to UE capabilities. Additionally, the feature of downlink control channel and procedure may have a second feature group (e.g., PDCCH monitoring of any span of up to 3 consecutive OFDM symbols of a slot) associated with an index value of 3-2 and having various components corresponding to other UE capabilities. In some aspects, one or more features, feature groups, feature sets, or a combination thereof, may be signaled to the network entity 105-a to indicate the capabilities of the UE. For instance, the UE 115-a may transmit a capability message to the network entity 105-a that include an indication (e.g., via one or more information elements) of feature sets (e.g., per CC) with one or more features supported by the UE 115-a.

In some examples, the UE 115-a may support processing of one or more DCIs in accordance with span-based PDCCH monitoring (e.g., up to two, four, or 7 PDCCH spans per slot). For example, in an FDD mode, the UE 115-a may support processing of one unicast DCI scheduling downlink per PDCCH span and processing of one unicast DCI scheduling uplink per PDCCH span. In a TDD mode, the UE 115-a may support processing of one unicast DCI scheduling downlink per PDCCH span and processing of two unicast DCIs scheduling uplink per PDCCH span, or the UE 115-a may support processing of two unicast DCIs scheduling downlink per PDCCH span and processing of one unicast DCI scheduling uplink per PDCCH span. In some examples, a PDCCH span may include one or more PMOs within consecutive symbols.

In some examples, the UE 115-a may support processing of one or more DCIs in accordance with cross-carrier scheduling with different SCSs. In a first example, the network entity 105-a may schedule a downlink DCI on a first carrier that schedules uplink or downlink communications for a second carrier, where the first carrier has a relatively lower SCS compared to the second carrier (e.g., lower to higher SCS scheduling). In such examples, the UE 115-a may process up to N unicast downlink DCIs per slot of the scheduling CC (e.g., the CC on which the DCI scheduling communications is received). For example, if the first carrier is associated with an SCS of 30 kHz and the second carrier is associated with an SCS of 60 kHz, the UE 115-a may receive and process two downlink DCIs per slot of the scheduling CC. In examples of a DCI scheduling uplink transmissions for an FDD mode, the UE 115-a may process a same quantity of uplink DCIs. In examples of a DCI scheduling uplink transmissions for a TDD mode, the UE 115-a may process two uplink DCIs per slot of the scheduling CC. In some aspects, a downlink DCI may refer to DCI that schedules downlink transmissions. Likewise, an uplink DCI may refer to DCI that schedules uplink transmissions.

In a second example, the network entity 105-a may schedule a DCI on a first carrier that schedules uplink or downlink communications for a second carrier where the first carrier has a higher SCS compared to the second carrier (e.g., higher to lower SCS scheduling). In such examples, the UE 115-a may process one DCI per N consecutive slots of the scheduling CC, where N is the ratio of the SCS associated with the first carrier and the SCS associated with the second carrier. For example, if the first carrier is associated with an SCS of 60 kHz and the second carrier is associated with an SCS of 30 kHz, the UE 115-a may schedule one DCI for two consecutive slots of the scheduling CC. In examples of scheduling uplink DCI for an FDD mode, the UE 115-a may process a same quantity of uplink DCIs. In examples of scheduling uplink DCI for a TDD mode, the UE 115-a may process two uplink DCIs per N consecutive slots of the scheduling CC.

The wireless communications system 200 may support mTRP operations. For example, a UE 115-a may communicate with multiple TRPs 205 (e.g., TRP 205-a and TRP 205-b) in uplink and downlink. For example, the UE 115-a may communicate with TRP 205-a using communication link 210-a and communicated with TRP 205-b using communication link 210-b. In the examples illustrated by FIG. 2, TRPs 205-a and 205-b are associated with the network entity 105-a, but the TRP 205-a and 205-b may be associated with respective network entities 105, and the examples described herein should not be considered limiting to the claims or the disclosure. That is, the UE 115-a may communicate with multiple network entities 105 via one or more respective TRPs 205.

In some cases, multiple DCI may be transmitted to the UE 115-a, where each TRP 205 may transmit a respective DCI. For instance, the UE 115-a may receive a first DCI from TRP 205-a, and the first DCI may schedule one or more downlink messages (e.g., physical downlink shared channel (PDSCH) transmissions) or one or more uplink messages (e.g., physical uplink shared channel (PUSCH) transmissions). The UE 115-a may also receive a second DCI from the TRP 205-b scheduling one or more downlink messages or one or more uplink messages.

Respective communications with each TRP 205 may, in some cases, be associated with different CORESET pool index values. For example, the UE 115-a may receive a control message configuring the UE 115-a for mTRP communications (e.g., in a given CC based on PDCCH-Config that contains two different values of CORESETPoolIndex in CORESETs for an active BWP of a serving cell). That is, each TRP 205 may be associated with a respective CORESET pool index 215 (e.g., CORESET pool index 215-a, CORESET pool index 215-b) having some value (e.g., 0 or 1). Each CORESET pool index 215 may be associated with one or more CORESET IDs 220 corresponding to a respective CORESET. For example, CORESET pool index 215-a may be associated with CORESET ID 220-a and 220-b, and CORESET pool index 215-b may be associated with CORESET ID 220-c and 220-d. Equivalently, the CORESETs with CORESET ID 220-a and 220-b may be associated with CORESET pool index 215-a (e.g., value 0), and CORESETs with CORESET ID 220-c and 220-d may be associated with CORESET pool index 215-b (value 1). Additionally, the UE 115-a may differentiate between the TRPs 205 (e.g., TRP 205-a and TRP 205-b) based on respective CORESET pool indices. In some examples, up to five CORESETs may be configured with a value of the CORESETPoolIndex.

In some examples, the TRP 205-a and 205-b may communicate concurrently with the UE 115-a using the respective CORESETPoolIndex values. For example, the TRP 205-a and 205-b may transmit respective PDSCHs (e.g., associated with different CORESETPoolIndex values) the may be partially or fully overlapping in time in a same CC. In some examples, a threshold quantity of PDSCHs that a given TRP 205 may transmit per slot (e.g., for TDM) may be defined per CORESETPoolIndex, which may be indicated by UE 115-a capability. Additionally, or alternatively, the UE 115-a may transmit to the TRP 205-a and 205-b, respective PUSCHs (e.g., associated with different CORESETPoolIndex values or sounding reference signal (SRS) resource sets) that may be partially or fully overlapping in time in a same CC (e.g., concurrent multi-panel transmission).

In some examples, the UE 115-a may be configured to monitor a larger quantity of PDCCHs in multi-DCI based mTRP compared to single-DCI operation. For example, the UE 115-a may support up to five CORESETs while using multi-DCI and up to three CORESETs while using sTRP (e.g., in a CC that is not associated with two CORESETPoolIndex values). In the example of multi-DCI, up to three CORESETs may be configured per CORESETPoolIndex value (e.g., per TRP 205). As such, the UE 115-a may monitor a relatively larger quantity of PDCCH candidates and non-overlapped CCEs while using multi-DCI based mTRP operations. That is, the threshold quantity of channels that the UE 115-a may monitor may be doubled (e.g., subject to UE 115-a capability) by treating a multi-DCI based mTRP CC as two virtual CCs.

While mTRP communications may be configured for a relatively increased quantity of uplink and/or downlink communications, a threshold quantity of downlink DCIs and uplink DCIs that the UE 115-a may process may remain associated with sTRP operation. That is, the capabilities associated with a quantity of uplink and/or downlink DCIs the UE 115-a is capable of detecting and processing per slot, per PMO, or per PDCCH span may be based on communications with a one TRP 205 instead of concurrent mTRP communications. In such cases, if the TRP 205-a and 205-b concurrently schedule two PDSCHs or two PUSCHs (e.g., in a same slot, PMO, or PDCCH span), the quantity of DCIs the UE 115-a may process may be in accordance with DCIs from a single TRP 205, effectively halving the quantity of DCIs each TRP 205 may transmit compared to sTRP operation (e.g., in a CC that is not associated with two CORESETPoolIndex values). As such, current DCI processing capability at the UE 115-a may be unable to support (e.g., may be inconsistent with) the PDSCH or PUSCH processing capability or PDCCH monitoring capability for mTRP operations.

To increase the processing capability of DCI for multi-DCI mTRP operations, the UE 115-a and network entity 105-a may operate in accordance with the techniques described herein. For example, the UE 115-a may transmit a capability message 225 to the network entity 105-a. In some examples, the capability message 225 may include a parameter indicating a capability associated with a threshold quantity of uplink and downlink DCIs that the UE 115-a may process for each scheduled CC associated with multiple (e.g., two) CORESETPoolIndex values. The threshold quantity indicated via the capability message 225 may be per slot, per PMO, or per PDCCH span.

In some examples, the UE 115-a may indicate, via the capability message 225, that the threshold quantity of DCIs may be associated with each CORESETPoolIndex value. In some examples, the indication of the threshold quantity may be a numeric value. Additionally, or alternatively, the indication of the threshold quantity may be relative to a second threshold quantity associated with CCs not configured with two CORESETPoolIndex values. That is, the UE 115-a may indicate, via the capability message 225, that the threshold quantity of DCI messages (for each CORESETPoolIndex value) is equal to a second threshold quantity of DCI messages the UE 115-a is capable of processing for CCs that may be associated with a single CORESETPoolIndex value or CCs not associated with any CORESETPoolIndex values.

In some examples, the UE 115-a may indicate, via the capability message 225, that the threshold quantity of DCIs may be the total quantity of DCIs across all of CORESETPoolIndex values. In some examples, the indication of the threshold quantity may be a numeric value. Additionally, or alternatively, the indication of the threshold quantity may be relative to a second threshold quantity associated with CCs configured for sTRP operation. That is, the UE 115-a may indicate via the capability message 225 that the threshold quantity of DCI messages (across both CORESETPoolIndex values) is double a second threshold quantity of DCI messages the UE 115-a is capable of processing for CCs that may be associated with a single CORESETPoolIndex value or CCs not associated with any CORESETPoolIndex values.

In some examples, the threshold quantity indicated via the capability message 225 may separately indicate respective threshold quantities for downlink DCIs and uplink DCIs. For example, the threshold quantity of DCI messages may include a first threshold quantity of DCI messages the UE 115-a is capable of processing for downlink communications and a second threshold quantity of DCI messages the UE 115-a is capable of processing for uplink communications.

Additionally, or alternatively, the capability message 225 may indicate respective threshold quantities for the quantity of uplink and downlink DCIs that the UE 115-a may process for respective monitoring configurations. For example, the respective types of monitoring occasions may include, but are not limited to slot-based PDCCH monitoring, span-based PDCCH monitoring, and multiple cross-carrier scheduling schemes. In some examples, a first cross-carrier scheduling scheme may be associated with a switch from a lower SCS carrier to a higher SCS carrier and a second cross-carrier scheduling scheme may be associated with a switch from a higher SCS carrier to a lower SCS carrier.

In some examples, the capability message 225 may have an associated granularity. For example, the granularity may be per UE 115, per band combination, per band, per band per band combination (e.g., per feature set (FS)), or per CC per band per combination (e.g., per FS per carrier).

In some examples, the UE 115-a may receive a CC configuration message 230, which may indicate a CC that is configured with multiple CORESETPoolIndex values. As such, a first CORESETPoolIndex value (e.g., CORESET pool index 215-a) may be associated with a first TRP 205 (e.g., TRP 205-a) and a second CORESETPoolIndex value (e.g., CORESET pool index 215-b) may be associated with a second TRP 205 (e.g., TRP 205-b) for the CC indicated in CC configuration message 230. In some examples, the CC configuration message may be a control message (e.g., RRC, a medium access control-control element (MAC-CE), or a DCI).

In some examples, the UE 115-a may receive one or more DCI messages 240 (e.g., from TRP 205-a, TRP 205-b, or both) associated with the CC indicated in CC configuration message 230. The quantity of DCI messages 240 may be based on the threshold quantity of DCI messages indicated via the capability message 225 and the CC being configured with the multiple CORESETPoolIndex values in CC configuration message 230.

In some cases, the network entity 105-a may enable the UE 115-a to process DCIs for CCs associated with multiple CORESETPoolIndex values using an RRC configuration. For example, the network entity 105-a may transmit an RRC configuration message 235 to enable the UE 115-a to process uplink and downlink DCIs for a scheduled CC associated with two CORESETPoolIndex values. In some examples, the network entity 105-a may transmit the RRC configuration message 235 based on receiving the capability message 225. As such, the RRC configuration message 235 may enable and disable UE 115-a capability to support DCI processing for CCs with multiple CORESETPoolIndex values. In some cases, the RRC configuration message 235 may be applicable to CCs or BWPs associated with two CORESETPoolIndex values. In cases of cross-carrier scheduling, the RRC configuration message 235 may be configured for the CC or BWP of the scheduled CC, for the on CC or BWP of the scheduling CC, or both. In some cases, the network entity 105-a may transmit respective RRC configuration messages 235 for respective cell groups. That is, a respective RRC configuration message 235 may be associated with CCs with two CORESETPoolIndex values for the associated cell group.

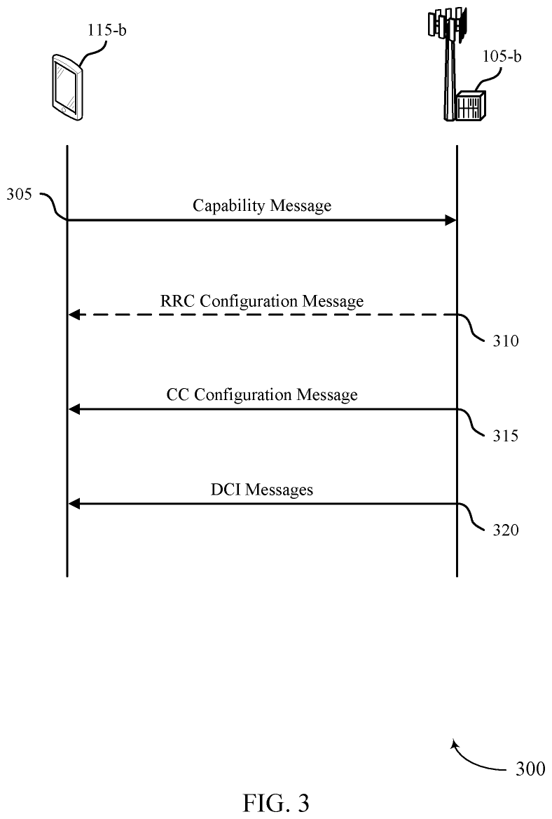

FIG. 3 illustrates an example of a process flow 300 that supports capabilities to process control information per CORESET pool index in accordance with one or more aspects of the present disclosure. In some examples, process flow 300 may implement aspects of wireless communications system 100 and wireless communications system 200. Process flow 300 includes a UE 115-b and a network entity 105-b which may be respective examples of a UE 115 and a network entity 105, as described with reference to FIGS. 1 and 2. Alternative examples of the following may be implemented, where some steps are performed in a different order than described or are not performed at all. In some cases, steps may include additional features not mentioned below, or further steps may be added. In addition, while process flow 300 shows processes between a single UE 115 and a single network entity 105, it should be understood that these processes may occur between any quantity of network devices and network device types.

At 305, the UE 115-b may transmit a capability message indicating a threshold quantity of DCI messages that the UE 115-b is capable of processing in a time duration for each CC that may be associated with multiple CORESETPoolIndex values. In some examples, the time duration may be a slot, a PDCCH span, or a PMO. In some examples, the threshold quantity of DCI messages may include a first threshold quantity of DCI messages the UE 115-b is capable of processing for downlink communications and a second threshold quantity of DCI messages the UE 115-b is capable of processing for uplink communications.

In some examples, the UE 115-b may indicate, via the capability message, that the threshold quantity of DCI messages may be for each of CORESETPoolIndex value of the multiple CORESETPoolIndex values. In some examples, the UE 115-b may indicate, via the capability message, that the threshold quantity of DCI messages is across the multiple CORESETPoolIndex values.

In some examples, the UE 115-b may indicate via the capability message, that the threshold quantity of DCI messages may be equal to a second threshold quantity of DCI messages the UE 115-b is capable of processing for CCs that are associated with a single CORESETPoolIndex value or for CCs that are not associated with a CORESETPoolIndex value. As such, the threshold quantity of DCI messages may be for each of CORESETPoolIndex value of the multiple CORESETPoolIndex values.

In some examples, the UE 115-b may indicate, via the capability message, that the threshold quantity of DCI messages may be double a second threshold quantity of DCI messages the UE 115-b is capable of processing for CCs that are associated with a single CORESETPoolIndex value or for CCs that are not associated with a CORESETPoolIndex value. As such, the threshold quantity of DCI messages may be across the multiple CORESETPoolIndex values.

In some examples, the UE 115-b may transmit as part of the capability message, respective threshold quantities of DCI messages each associated with respective monitoring configurations. For example, the monitoring configurations may include one or more of a slot-based PDCCH monitoring, a span-based PDCCH monitoring, a first cross-carrier scheduling scheme associated with a switch from a lower SCS to a higher SCS, and a second cross-carrier scheduling scheme associated with a switch from the higher SCS to the lower SCS. In some examples, the capability message may be associated with a band combination, a band, a band of a band combination, a CC of a band of a band combination, or a combination thereof.

At 310, the UE 115-b may receive a control message (e.g., RRC configuration message 235, with reference to FIG. 2) indicating a control information configuration that enables the UE 115-b to process the threshold quantity of DCI messages for each CC that is associated with the multiple CORESETPoolIndex values. In some examples, the control information configuration may be based on the capability message. In some examples, the UE 115-b may receive one or more DCI messages (e.g., at 320) based on receiving the control message. In some examples, the control information configuration may enable for the UE 115-b to process DCI messages for each CC of a set of CCs that are included in a cell group and associated with the multiple CORESETPoolIndex values.

In some examples, the control information configuration may enable the UE 115-b to process DCI messages for a first CC, or a BWP, or both, associated with the multiple CORESETPoolIndex values. In such examples, the first CC, or the BWP, or both, may be a scheduling CC including first control information that schedules an uplink transmission or a downlink transmission for a second CC different from the scheduling CC. Additionally, or alternatively, the first CC, or the BWP, or both, may be a scheduled CC including the downlink transmission or the uplink transmission scheduled by second control information received via a third CC different from the scheduled CC.

At 315, the UE 115-b may receive a control message (e.g., CC configuration message 230, with reference to FIG. 2) indicating that a CC is configured with the multiple CORESETPoolIndex values.

At 320, the UE 115-b may receive one or more DCI messages associated with the CC based on the threshold quantity of DCI messages and the CC being configured with the multiple CORESETPoolIndex values. In some examples, a first TRP may be associated with a first CORESETPoolIndex value of the multiple CORESETPoolIndex values and a second TRP may be associated with a second CORESETPoolIndex value of the multiple CORESETPoolIndex values. As such, the UE 115-b may receive the one or more DCI messages via the first TRP, the second TRP, or both.

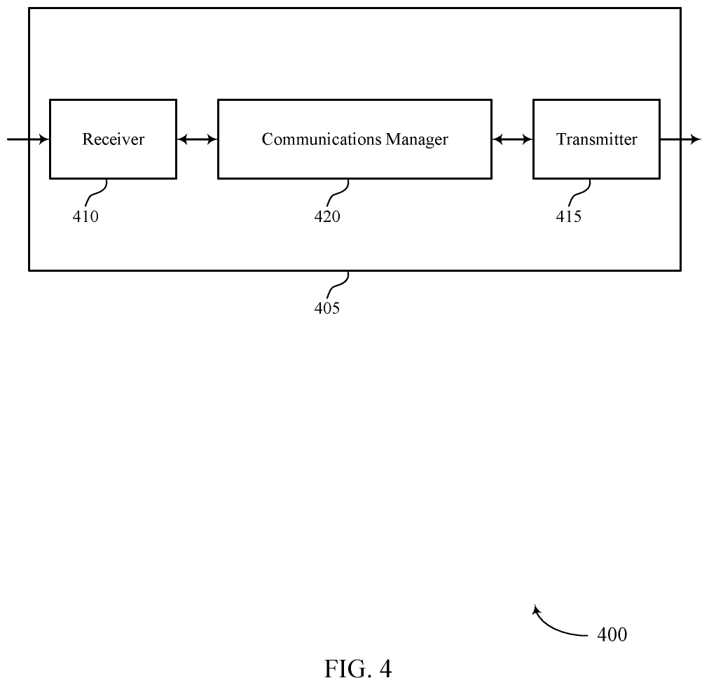

FIG. 4 illustrates a block diagram 400 of a device 405 that supports capabilities to process control information per CORESET pool index in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to capability to process control information per CORESET pool index). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to capability to process control information per CORESET pool index). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of capability to process control information per CORESET pool index as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 may be configured as or otherwise support a means for transmitting a capability message indicating a threshold quantity of DCI messages the UE is capable of processing in a time duration for each CC that is associated with a set of multiple CORESET pool index values. The communications manager 420 may be configured as or otherwise support a means for receiving a first control message indicating that a CC is configured with the set of multiple CORESET pool index values. The communications manager 420 may be configured as or otherwise support a means for receiving one or more DCI messages associated with the CC based on the threshold quantity of DCI messages and the CC being configured with the set of multiple CORESET pool index values.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for more efficient utilization of communication resources and an increased performance of multicast operations.

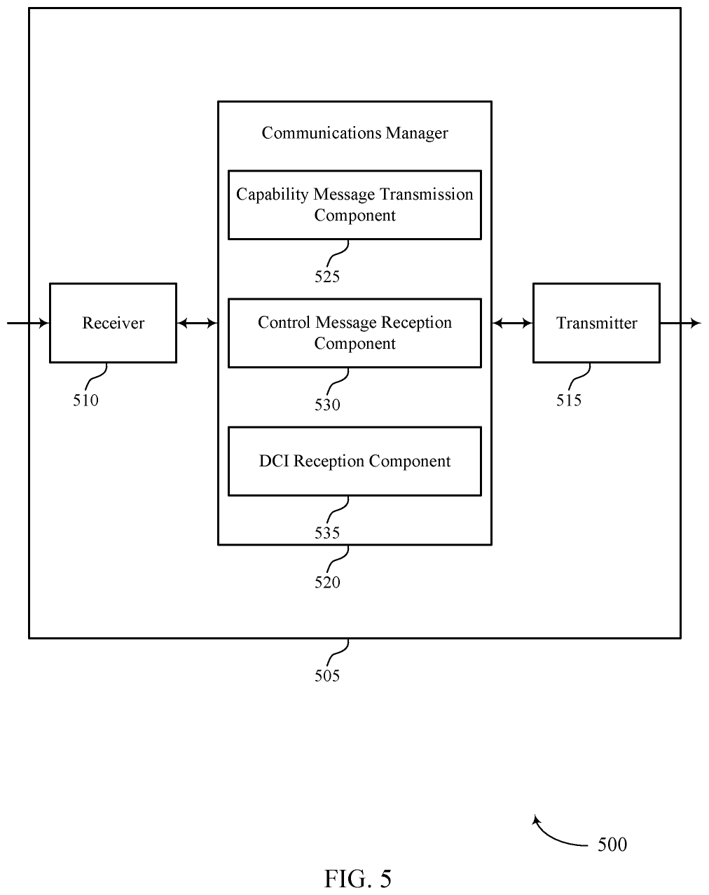

FIG. 5 illustrates a block diagram 500 of a device 505 that supports capabilities to process control information per CORESET pool index in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to capability to process control information per CORESET pool index). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to capability to process control information per CORESET pool index). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of capability to process control information per CORESET pool index as described herein. For example, the communications manager 520 may include a capability message transmission component 525, a control message reception component 530, a DCI reception component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The capability message transmission component 525 may be configured as or otherwise support a means for transmitting a capability message indicating a threshold quantity of DCI messages the UE is capable of processing in a time duration for each CC that is associated with a set of multiple CORESET pool index values. The capability message transmission component 525 and/or at least some of its various sub-components may be physically located at various positions, including being distributed such that portions of functions are implemented at different physical locations by one or more physical devices. In some examples, the capability message transmission component 525 and/or at least some of its various sub-components may be a separate and distinct component in accordance with various aspects of the present disclosure. In other examples, the capability message transmission component 525 and/or at least some of its various sub-components may be combined with one or more other hardware components, including but not limited to a receiver (e.g., receiver 510), a transmitter (e.g., transmitter 515), a transceiver, one or more other components described in the present disclosure, or a combination thereof, in accordance with various aspects of the present disclosure.

The control message reception component 530 may be configured as or otherwise support a means for receiving a first control message indicating that a CC is configured with the set of multiple CORESET pool index values. The control message reception component 530 and/or at least some of its various sub-components may be physically located at various positions, including being distributed such that portions of functions are implemented at different physical locations by one or more physical devices. In some examples, the control message reception component 530 and/or at least some of its various sub-components may be a separate and distinct component in accordance with various aspects of the present disclosure. In other examples, the control message reception component 530 and/or at least some of its various sub-components may be combined with one or more other hardware components, including but not limited to a receiver (e.g., receiver 510), a transmitter (e.g., transmitter 515), a transceiver, one or more other components described in the present disclosure, or a combination thereof, in accordance with various aspects of the present disclosure.

The DCI reception component 535 may be configured as or otherwise support a means for receiving one or more DCI messages associated with the CC based on the threshold quantity of DCI messages and the CC being configured with the set of multiple CORESET pool index values. The DCI reception component 535 and/or at least some of its various sub-components may be physically located at various positions, including being distributed such that portions of functions are implemented at different physical locations by one or more physical devices. In some examples, the DCI reception component 535 and/or at least some of its various sub-components may be a separate and distinct component in accordance with various aspects of the present disclosure. In other examples, the DCI reception component 535 and/or at least some of its various sub-components may be combined with one or more other hardware components, including but not limited to a receiver (e.g., receiver 510), a transmitter (e.g., transmitter 515), a transceiver, one or more other components described in the present disclosure, or a combination thereof, in accordance with various aspects of the present disclosure.

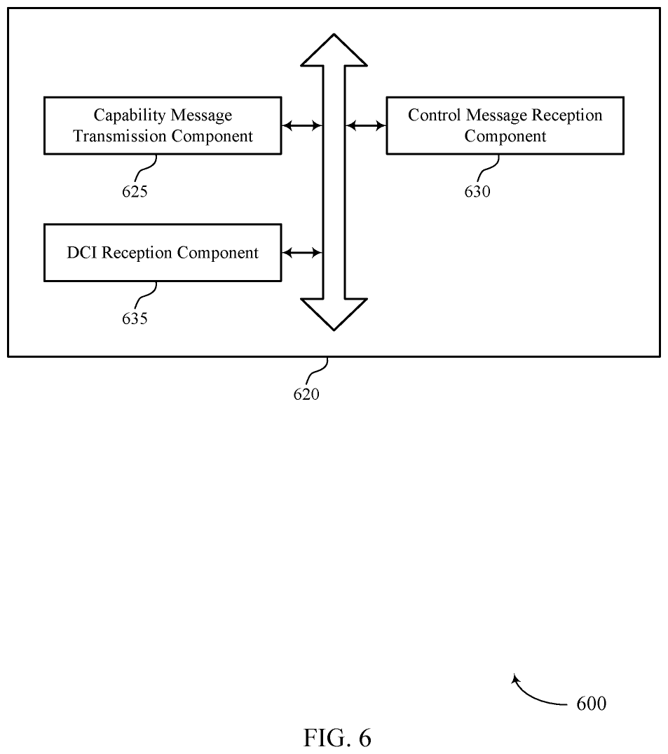

FIG. 6 illustrates a block diagram 600 of a communications manager 620 that supports capabilities to process control information per CORESET pool index in accordance with one or more aspects of the present disclosure. The communications manager 620 may be an example of aspects of a communications manager 420, a communications manager 520, or both, as described herein. The communications manager 620, or various components thereof, may be an example of means for performing various aspects of capability to process control information per CORESET pool index as described herein. For example, the communications manager 620 may include a capability message transmission component 625, a control message reception component 630, a DCI reception component 635, or any combination thereof. Each of these components may communicate, directly or indirectly, with one another (e.g., via one or more buses).

The communications manager 620 may support wireless communications in accordance with examples as disclosed herein. The capability message transmission component 625 may be configured as or otherwise support a means for transmitting a capability message indicating a threshold quantity of DCI messages the UE is capable of processing in a time duration for each CC that is associated with a set of multiple CORESET pool index values. The control message reception component 630 may be configured as or otherwise support a means for receiving a first control message indicating that a CC is configured with the set of multiple CORESET pool index values. The DCI reception component 635 may be configured as or otherwise support a means for receiving one or more DCI messages associated with the CC based on the threshold quantity of DCI messages and the CC being configured with the set of multiple CORESET pool index values.

In some examples, the control message reception component 630 may be configured as or otherwise support a means for receiving a second control message indicating a control information configuration that enables the UE to process the threshold quantity of DCI messages for each CC that is associated with the set of multiple CORESET pool index values, the control information configuration being based on the capability message, where receiving the one or more DCI messages is based on receiving the second control message.

In some examples, the control information configuration enables the UE to process DCI messages for a first CC, or a BWP, or both, associated with the set of multiple CORESET pool index values.

In some examples, the first CC, or the BWP, or both, includes a scheduling CC including first control information that schedules an uplink transmission or a downlink transmission for a second CC different from the scheduling CC. In some examples, the first CC, or the BWP, or both, includes a scheduled CC including the downlink transmission or the uplink transmission scheduled by second control information received via a third CC different from the scheduled CC.

In some examples, the control information configuration enables for the UE to process DCI messages for each CC of a set of CCs that are included in a cell group and associated with the set of multiple CORESET pool index values.

In some examples, the capability message transmission component 625 may be configured as or otherwise support a means for indicating, via the capability message, that the threshold quantity of DCI messages is for each of CORESET pool index value of the set of multiple CORESET pool index values.

In some examples, the capability message transmission component 625 may be configured as or otherwise support a means for indicating, via the capability message, that the threshold quantity of DCI messages is across the set of multiple CORESET pool index values.

In some examples, the capability message transmission component 625 may be configured as or otherwise support a means for indicating, via the capability message, that the threshold quantity of DCI messages is equal to a second threshold quantity of DCI messages the UE is capable of processing for CCs that are associated with a single CORESET pool index value or for CCs that are not associated with a CORESET pool index value, where the threshold quantity of DCI messages is for each of CORESET pool index value of the set of multiple CORESET pool index values.

In some examples, the capability message transmission component 625 may be configured as or otherwise support a means for indicating, via the capability message, that the threshold quantity of DCI messages is double a second threshold quantity of DCI messages the UE is capable of processing for CCs that are associated with a single CORESET pool index value or for CCs that are not associated with a CORESET pool index value.

In some examples, the threshold quantity of DCI messages includes a first threshold quantity of DCI messages the UE is capable of processing for downlink communications and a second threshold quantity of DCI messages the UE is capable of processing for uplink communications.

In some examples, to support transmitting the capability message, the capability message transmission component 625 may be configured as or otherwise support a means for transmitting, as part of the capability message, respective threshold quantities of DCI messages each associated with respective monitoring configurations.

In some examples, the respective monitoring configurations include one or more of a slot-based downlink control channel monitoring, a span-based downlink control channel monitoring, a first cross-carrier scheduling scheme associated with a switch from a lower SCS to a higher SCS, and a second cross-carrier scheduling scheme associated with a switch from the higher SCS to the lower SCS.

In some examples, the capability message is associated with a band combination, a band, a band of a band combination, a CC of a band of a band combination, or a combination thereof.

In some examples, a first TRP is associated with a first CORESET pool index value of the set of multiple CORESET pool index values and a second TRP is associated with a second CORESET pool index value of the set of multiple CORESET pool index values. In some examples, the one or more DCI messages are received via the first TRP, the second TRP, or both. In some examples, the time duration is a slot, a PDCCH span, or a PDCCH monitoring occasion.

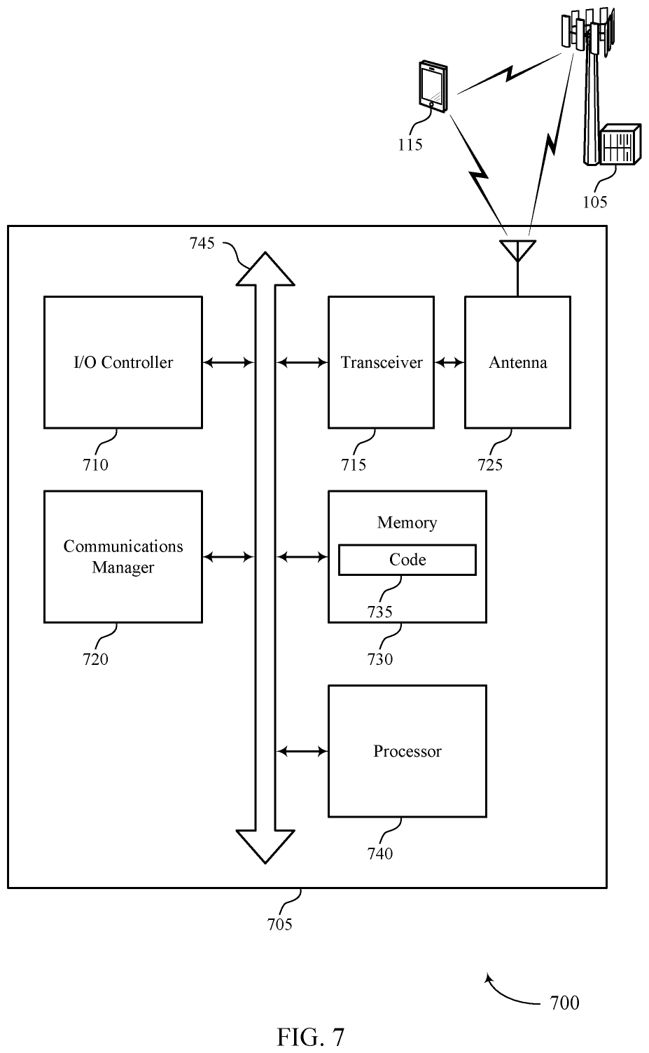

FIG. 7 illustrates a diagram of a system 700 including a device 705 that supports capabilities to process control information per CORESET pool index in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting capability to process control information per CORESET pool index). For example, the device 705 or a component of the device 705 may include a processor 740 and memory 730 coupled with or to the processor 740, the processor 740 and memory 730 configured to perform various functions described herein.

The communications manager 720 may support wireless communications in accordance with examples as disclosed herein. For example, the communications manager 720 may be configured as or otherwise support a means for transmitting a capability message indicating a threshold quantity of DCI messages the UE is capable of processing in a time duration for each CC that is associated with a set of multiple CORESET pool index values. The communications manager 720 may be configured as or otherwise support a means for receiving a first control message indicating that a CC is configured with the set of multiple CORESET pool index values. The communications manager 720 may be configured as or otherwise support a means for receiving one or more DCI messages associated with the CC based on the threshold quantity of DCI messages and the CC being configured with the set of multiple CORESET pool index values.

By including or configuring the communications manager 720 in accordance with examples as described herein, the device 705 may support techniques for improved communication reliability, reduced latency, improved user experience related to reduced processing, more efficient utilization of communication resources, improved coordination between devices, and an increased performance of multicast operations.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of capability to process control information per CORESET pool index as described herein, or the processor 740 and the memory 730 may be otherwise configured to perform or support such operations.

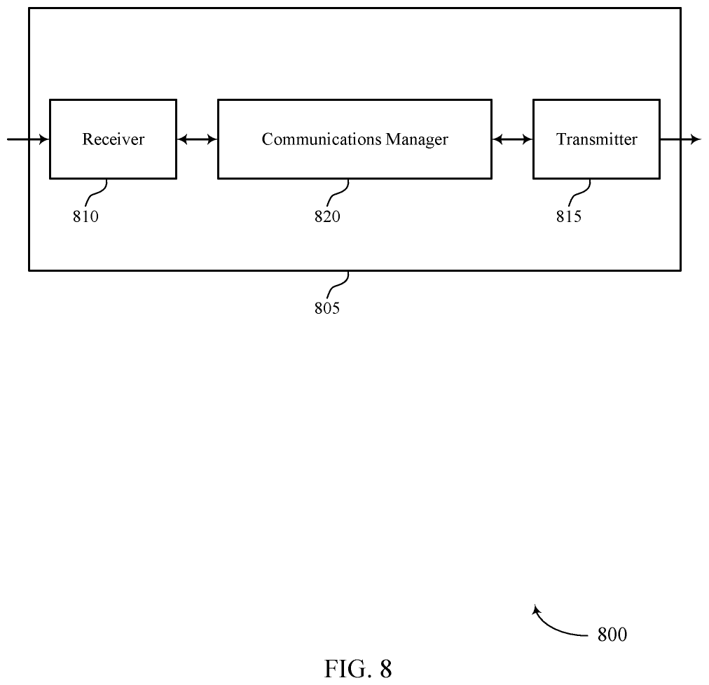

FIG. 8 illustrates a block diagram 800 of a device 805 that supports capabilities to process control information per CORESET pool index in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of capability to process control information per CORESET pool index as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 may be configured as or otherwise support a means for receiving, from a UE, a capability message indicating a threshold quantity of DCI messages the UE is capable of processing in a time duration for each CC that is associated with a set of multiple CORESET pool index values. The communications manager 820 may be configured as or otherwise support a means for transmitting a first control message indicating that a CC is configured with the set of multiple CORESET pool index values. The communications manager 820 may be configured as or otherwise support a means for transmitting one or more DCI messages associated with the CC based on the threshold quantity of DCI messages and the CC being configured with the set of multiple CORESET pool index values.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for more efficient utilization of communication resources and an increased performance of multicast operations.

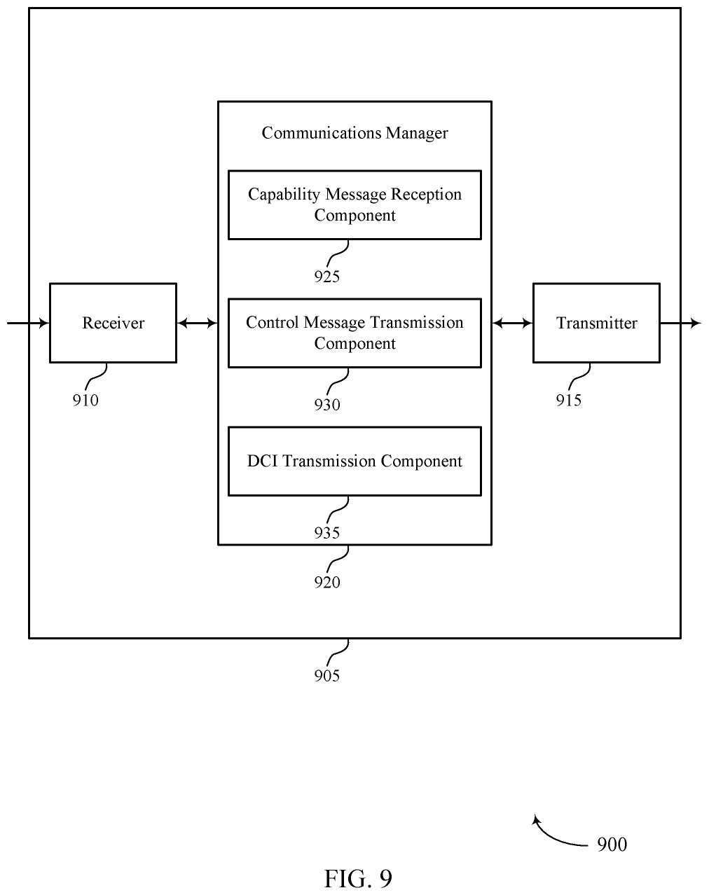

FIG. 9 illustrates a block diagram 900 of a device 905 that supports capabilities to process control information per CORESET pool index in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of capability to process control information per CORESET pool index as described herein. For example, the communications manager 920 may include a capability message reception component 925, a control message transmission component 930, a DCI transmission component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The capability message reception component 925 may be configured as or otherwise support a means for receiving, from a UE, a capability message indicating a threshold quantity of DCI messages the UE is capable of processing in a time duration for each CC that is associated with a set of multiple CORESET pool index values. The capability message reception component 925 and/or at least some of its various sub-components may be physically located at various positions, including being distributed such that portions of functions are implemented at different physical locations by one or more physical devices. In some examples, the capability message reception component 925 and/or at least some of its various sub-components may be a separate and distinct component in accordance with various aspects of the present disclosure. In other examples, the capability message reception component 925 and/or at least some of its various sub-components may be combined with one or more other hardware components, including but not limited to a receiver (e.g., receiver 910), a transmitter (e.g., transmitter 915), a transceiver, one or more other components described in the present disclosure, or a combination thereof, in accordance with various aspects of the present disclosure.

The control message transmission component 930 may be configured as or otherwise support a means for transmitting a first control message indicating that a CC is configured with the set of multiple CORESET pool index values. The control message transmission component 930 and/or at least some of its various sub-components may be physically located at various positions, including being distributed such that portions of functions are implemented at different physical locations by one or more physical devices. In some examples, the control message transmission component 930 and/or at least some of its various sub-components may be a separate and distinct component in accordance with various aspects of the present disclosure. In other examples, the control message transmission component 930 and/or at least some of its various sub-components may be combined with one or more other hardware components, including but not limited to a receiver (e.g., receiver 910), a transmitter (e.g., transmitter 915), a transceiver, one or more other components described in the present disclosure, or a combination thereof, in accordance with various aspects of the present disclosure.

The DCI transmission component 935 may be configured as or otherwise support a means for transmitting one or more DCI messages associated with the CC based on the threshold quantity of DCI messages and the CC being configured with the set of multiple CORESET pool index values. The DCI transmission component 935 and/or at least some of its various sub-components may be physically located at various positions, including being distributed such that portions of functions are implemented at different physical locations by one or more physical devices. In some examples, the DCI transmission component 935 and/or at least some of its various sub-components may be a separate and distinct component in accordance with various aspects of the present disclosure. In other examples, the DCI transmission component 935 and/or at least some of its various sub-components may be combined with one or more other hardware components, including but not limited to a receiver (e.g., receiver 910), a transmitter (e.g., transmitter 915), a transceiver, one or more other components described in the present disclosure, or a combination thereof, in accordance with various aspects of the present disclosure.

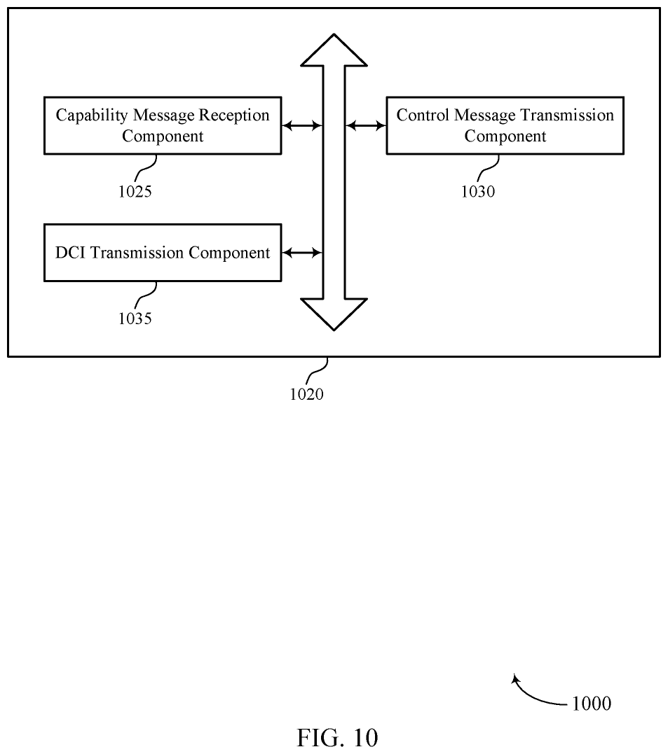

FIG. 10 illustrates a block diagram 1000 of a communications manager 1020 that supports capabilities to process control information per CORESET pool index in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of capability to process control information per CORESET pool index as described herein. For example, the communications manager 1020 may include a capability message reception component 1025, a control message transmission component 1030, a DCI transmission component 1035, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The capability message reception component 1025 may be configured as or otherwise support a means for receiving, from a UE, a capability message indicating a threshold quantity of DCI messages the UE is capable of processing in a time duration for each CC that is associated with a set of multiple CORESET pool index values. The control message transmission component 1030 may be configured as or otherwise support a means for transmitting a first control message indicating that a CC is configured with the set of multiple CORESET pool index values. The DCI transmission component 1035 may be configured as or otherwise support a means for transmitting one or more DCI messages associated with the CC based on the threshold quantity of DCI messages and the CC being configured with the set of multiple CORESET pool index values.

In some examples, the control message transmission component 1030 may be configured as or otherwise support a means for transmitting a second control message indicating a control information configuration that enables the UE to process the threshold quantity of DCI messages for each CC that is associated with the set of multiple CORESET pool index values, the control information configuration being based on the capability message, where transmitting the one or more DCI messages is based on transmitting the second control message.

In some examples, the control information configuration enables the UE to process DCI messages for a first CC, or a BWP, or both, associated with the set of multiple CORESET pool index values.

In some examples, the first CC, or the BWP, or both, includes a scheduling CC including first control information that schedules an uplink transmission or a downlink transmission for a second CC different from the scheduling CC. In some examples, the first CC, or the BWP, or both, includes a scheduled CC including the downlink transmission or the uplink transmission scheduled by second control information received via a third CC different from the scheduled CC.

In some examples, the control information configuration enables for the UE to process DCI messages for each CC of a set of CCs that are included in a cell group and associated with the set of multiple CORESET pool index values.

In some examples, the capability message reception component 1025 may be configured as or otherwise support a means for receiving, via the capability message, an indication that the threshold quantity of DCI messages is for each of CORESET pool index value of the set of multiple CORESET pool index values.

In some examples, the capability message reception component 1025 may be configured as or otherwise support a means for receiving, via the capability message, an indication that the threshold quantity of DCI messages is across the set of multiple CORESET pool index values.

In some examples, the capability message reception component 1025 may be configured as or otherwise support a means for receiving, via the capability message, an indication that the threshold quantity of DCI messages is equal to a second threshold quantity of DCI messages the UE is capable of processing for CCs that are associated with a single CORESET pool index value or for CCs that are not associated with a CORESET pool index value, where the threshold quantity of DCI messages is for each of CORESET pool index value of the set of multiple CORESET pool index values.

In some examples, the capability message reception component 1025 may be configured as or otherwise support a means for receiving, via the capability message, an indication that the threshold quantity of DCI messages is double a second threshold quantity of DCI messages the UE is capable of processing for CCs that are associated with a single CORESET pool index value or for CCs that are not associated with a CORESET pool index value.

In some examples, the threshold quantity of DCI messages includes a first threshold quantity of DCI messages the UE is capable of processing for downlink communications and a second threshold quantity of DCI messages the UE is capable of processing for uplink communications.

In some examples, to support receiving the capability message, the capability message reception component 1025 may be configured as or otherwise support a means for receiving, as part of the capability message, respective threshold quantities of DCI messages each associated with respective monitoring configurations.

In some examples, the respective monitoring configurations include one or more of a slot-based downlink control channel monitoring, a span-based downlink control channel monitoring, a first cross-carrier scheduling scheme associated with a switch from a lower SCS to a higher SCS, and a second cross-carrier scheduling scheme associated with a switch from the higher SCS to the lower SCS.

In some examples, the capability message is associated with a band combination, a band, a band of a band combination, a CC of a band of a band combination, or a combination thereof.

In some examples, a first TRP of the network entity is associated with a first CORESET pool index value of the set of multiple CORESET pool index values and a second TRP of the network entity is associated with a second CORESET pool index value of the set of multiple CORESET pool index values. In some examples, the one or more DCI messages are transmitted via the first TRP, the second TRP, or both. In some examples, the time duration is a slot, a PDCCH span, or a PDCCH monitoring occasion.

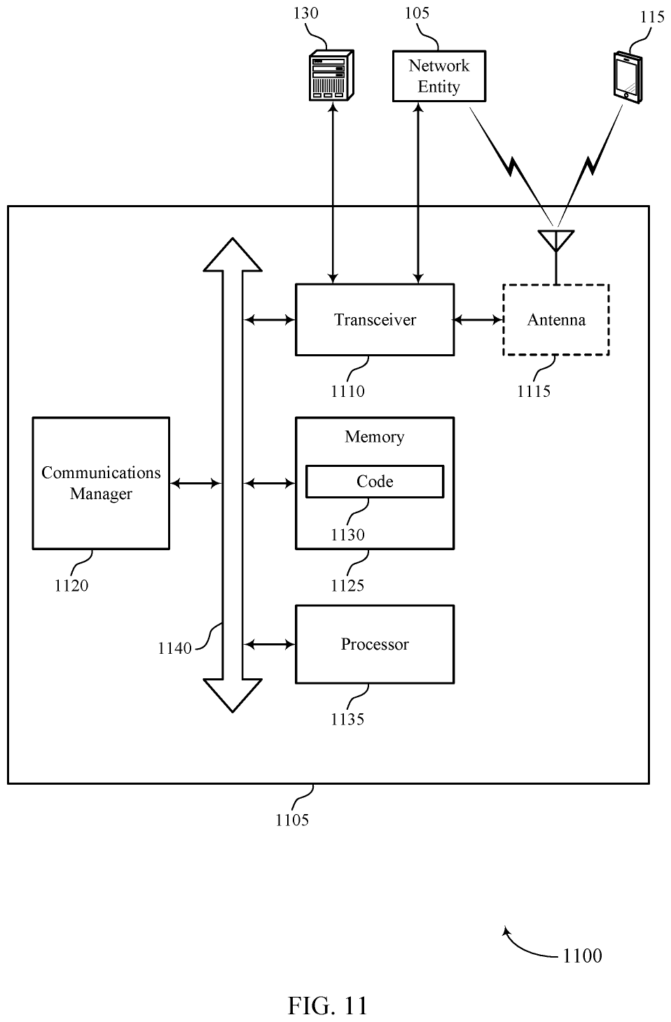

FIG. 11 illustrates a diagram of a system 1100 including a device 1105 that supports capabilities to process control information per CORESET pool index in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting capability to process control information per CORESET pool index). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 may be configured as or otherwise support a means for receiving, from a UE, a capability message indicating a threshold quantity of DCI messages the UE is capable of processing in a time duration for each CC that is associated with a set of multiple CORESET pool index values. The communications manager 1120 may be configured as or otherwise support a means for transmitting a first control message indicating that a CC is configured with the set of multiple CORESET pool index values. The communications manager 1120 may be configured as or otherwise support a means for transmitting one or more DCI messages associated with the CC based on the threshold quantity of DCI messages and the CC being configured with the set of multiple CORESET pool index values.

By including or configuring the communications manager 1120 in accordance with examples as described herein, the device 1105 may support techniques for improved communication reliability, reduced latency, improved user experience related to reduced processing, more efficient utilization of communication resources, improved coordination between devices, and an increased performance of multicast operations.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of capability to process control information per CORESET pool index as described herein, or the processor 1135 and the memory 1125 may be otherwise configured to perform or support such operations.

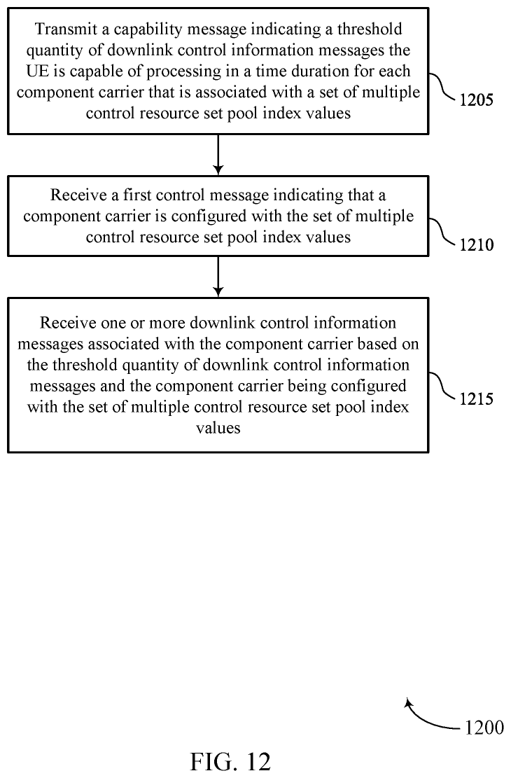

FIG. 12 illustrates a flowchart showing a method 1200 that supports capabilities to process control information per CORESET pool index in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include transmitting a capability message indicating a threshold quantity of DCI messages the UE is capable of processing in a time duration for each CC that is associated with a set of multiple CORESET pool index values. The operations of 1205 may be performed in accordance with examples as disclosed herein. In some examples, aspects of the operations of 1205 may be performed by a capability message transmission component 625 as described with reference to FIG. 6.

At 1210, the method may include receiving a first control message indicating that a CC is configured with the set of multiple CORESET pool index values. The operations of 1210 may be performed in accordance with examples as disclosed herein. In some examples, aspects of the operations of 1210 may be performed by a control message reception component 630 as described with reference to FIG. 6.

At 1215, the method may include receiving one or more DCI messages associated with the CC based on the threshold quantity of DCI messages and the CC being configured with the set of multiple CORESET pool index values. The operations of 1215 may be performed in accordance with examples as disclosed herein. In some examples, aspects of the operations of 1215 may be performed by a DCI reception component 635 as described with reference to FIG. 6.

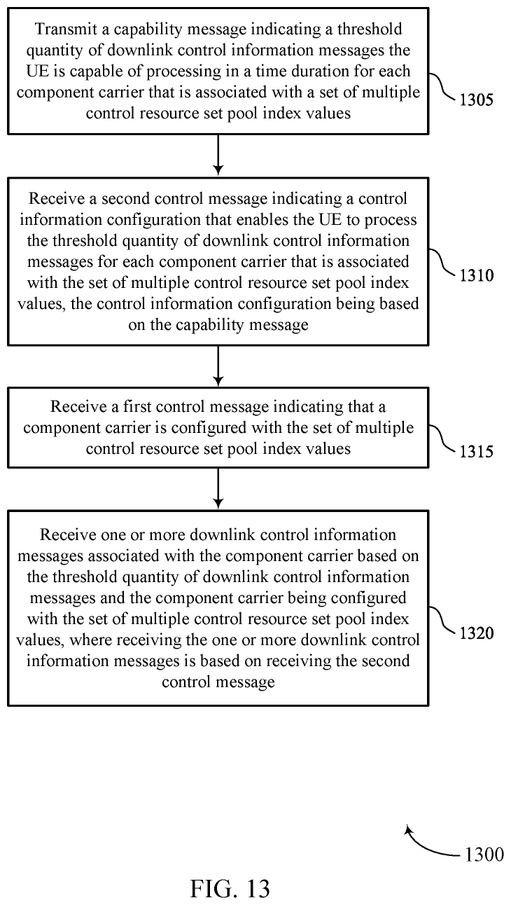

FIG. 13 illustrates a flowchart showing a method 1300 that supports capabilities to process control information per CORESET pool index in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include transmitting a capability message indicating a threshold quantity of DCI messages the UE is capable of processing in a time duration for each CC that is associated with a set of multiple CORESET pool index values. The operations of 1305 may be performed in accordance with examples as disclosed herein. In some examples, aspects of the operations of 1305 may be performed by a capability message transmission component 625 as described with reference to FIG. 6.

At 1310, the method may include receiving a second control message indicating a control information configuration that enables the UE to process the threshold quantity of DCI messages for each CC that is associated with the set of multiple CORESET pool index values, the control information configuration being based on the capability message. The operations of 1310 may be performed in accordance with examples as disclosed herein. In some examples, aspects of the operations of 1310 may be performed by a control message reception component 630 as described with reference to FIG. 6.

At 1315, the method may include receiving a first control message indicating that a CC is configured with the set of multiple CORESET pool index values. The operations of 1315 may be performed in accordance with examples as disclosed herein. In some examples, aspects of the operations of 1315 may be performed by a control message reception component 630 as described with reference to FIG. 6.

At 1320, the method may include receiving one or more DCI messages associated with the CC based on the threshold quantity of DCI messages and the CC being configured with the set of multiple CORESET pool index values, where receiving the one or more DCI messages is based on receiving the second control message. The operations of 1320 may be performed in accordance with examples as disclosed herein. In some examples, aspects of the operations of 1320 may be performed by a DCI reception component 635 as described with reference to FIG. 6.

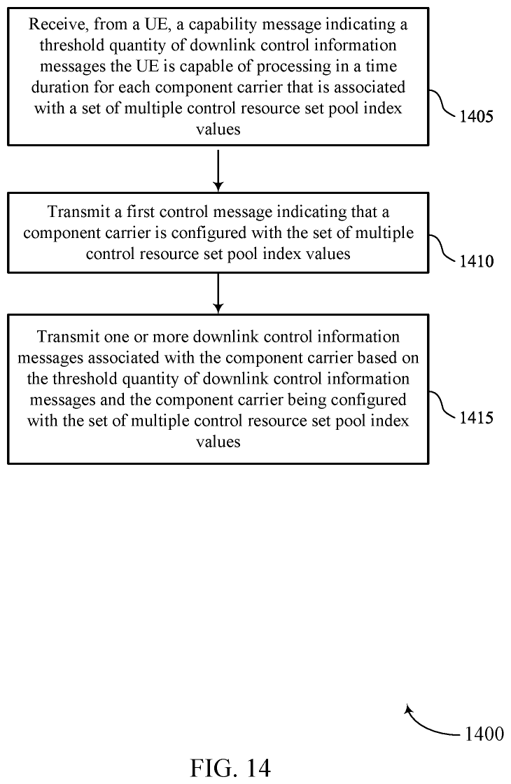

FIG. 14 illustrates a flowchart showing a method 1400 that supports capabilities to process control information per CORESET pool index in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include receiving, from a UE, a capability message indicating a threshold quantity of DCI messages the UE is capable of processing in a time duration for each CC that is associated with a set of multiple CORESET pool index values. The operations of 1405 may be performed in accordance with examples as disclosed herein. In some examples, aspects of the operations of 1405 may be performed by a capability message reception component 1025 as described with reference to FIG. 10.

At 1410, the method may include transmitting a first control message indicating that a CC is configured with the set of multiple CORESET pool index values. The operations of 1410 may be performed in accordance with examples as disclosed herein. In some examples, aspects of the operations of 1410 may be performed by a control message transmission component 1030 as described with reference to FIG. 10.

At 1415, the method may include transmitting one or more DCI messages associated with the CC based on the threshold quantity of DCI messages and the CC being configured with the set of multiple CORESET pool index values. The operations of 1415 may be performed in accordance with examples as disclosed herein. In some examples, aspects of the operations of 1415 may be performed by a DCI transmission component 1035 as described with reference to FIG. 10.

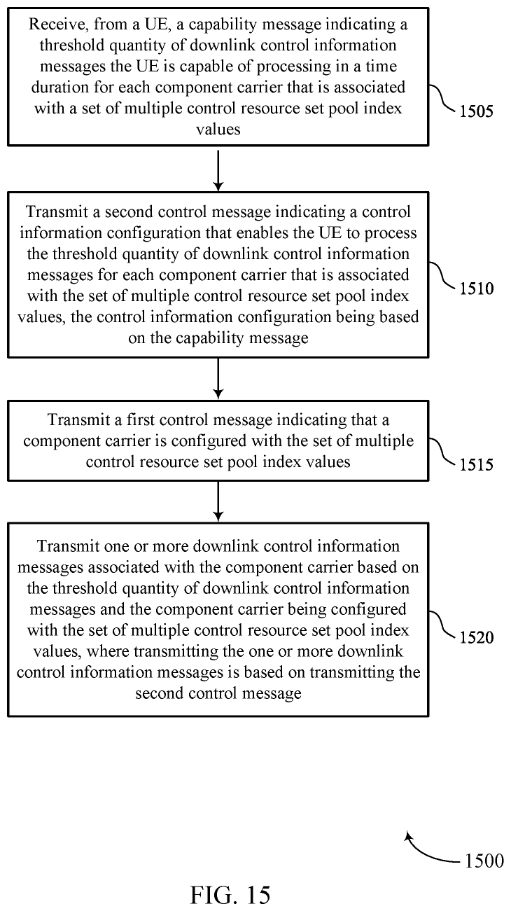

FIG. 15 illustrates a flowchart showing a method 1500 that supports capabilities to process control information per CORESET pool index in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include receiving, from a UE, a capability message indicating a threshold quantity of DCI messages the UE is capable of processing in a time duration for each CC that is associated with a set of multiple CORESET pool index values. The operations of 1505 may be performed in accordance with examples as disclosed herein. In some examples, aspects of the operations of 1505 may be performed by a capability message reception component 1025 as described with reference to FIG. 10.

At 1510, the method may include transmitting a second control message indicating a control information configuration that enables the UE to process the threshold quantity of DCI messages for each CC that is associated with the set of multiple CORESET pool index values, the control information configuration being based on the capability message. The operations of 1510 may be performed in accordance with examples as disclosed herein. In some examples, aspects of the operations of 1510 may be performed by a control message transmission component 1030 as described with reference to FIG. 10.

At 1515, the method may include transmitting a first control message indicating that a CC is configured with the set of multiple CORESET pool index values. The operations of 1515 may be performed in accordance with examples as disclosed herein. In some examples, aspects of the operations of 1515 may be performed by a control message transmission component 1030 as described with reference to FIG. 10.

At 1520, the method may include transmitting one or more DCI messages associated with the CC based on the threshold quantity of DCI messages and the CC being configured with the set of multiple CORESET pool index values, where transmitting the one or more DCI messages is based on transmitting the second control message. The operations of 1520 may be performed in accordance with examples as disclosed herein. In some examples, aspects of the operations of 1520 may be performed by a DCI transmission component 1035 as described with reference to FIG. 10.

The following provides an overview of aspects of the present disclosure:

Aspect 1: A method for wireless communications, at a UE, comprising: transmitting a capability message indicating a threshold quantity of DCI messages the UE is capable of processing in a time duration for each CC that is associated with a plurality of CORESET pool index values; receiving a first control message indicating that a CC is configured with the plurality of CORESET pool index values; and receiving one or more DCI messages associated with the CC based at least in part on the threshold quantity of DCI messages and the CC being configured with the plurality of CORESET pool index values.

Aspect 2: The method of aspect 1, further comprising: receiving a second control message indicating a control information configuration that enables the UE to process the threshold quantity of DCI messages for each CC that is associated with the plurality of CORESET pool index values, the control information configuration being based at least in part on the capability message, wherein receiving the one or more DCI messages is based at least in part on receiving the second control message.

Aspect 3: The method of aspect 2, wherein the control information configuration enables the UE to process DCI messages for a first CC, or a BWP, or both, associated with the plurality of CORESET pool index values.

Aspect 4: The method of aspect 3, wherein the first CC, or the BWP, or both, comprises a scheduling CC including first control information that schedules an uplink transmission or a downlink transmission for a second CC different from the scheduling CC; or the first CC, or the BWP, or both, comprises a scheduled CC including the downlink transmission or the uplink transmission scheduled by second control information received via a third CC different from the scheduled CC.

Aspect 5: The method of any of aspects 2 through 4, wherein the control information configuration enables for the UE to process DCI messages for each CC of a set of CCs that are included in a cell group and associated with the plurality of CORESET pool index values.

Aspect 6: The method of any of aspects 1 through 5, further comprising: indicating, via the capability message, that the threshold quantity of DCI messages is for each of CORESET pool index value of the plurality of CORESET pool index values.

Aspect 7: The method of any of aspects 1 through 5, further comprising: indicating, via the capability message, that the threshold quantity of DCI messages is across the plurality of CORESET pool index values.

Aspect 8: The method of any of aspects 1 through 7, further comprising: indicating, via the capability message, that the threshold quantity of DCI messages is equal to a second threshold quantity of DCI messages the UE is capable of processing for CCs that are associated with a single CORESET pool index value or for CCs that are not associated with a CORESET pool index value, wherein the threshold quantity of DCI messages is for each of CORESET pool index value of the plurality of CORESET pool index values.

Aspect 9: The method of any of aspects 1 through 7, further comprising: indicating, via the capability message, that the threshold quantity of DCI messages is double a second threshold quantity of DCI messages the UE is capable of processing for CCs that are associated with a single CORESET pool index value or for CCs that are not associated with a CORESET pool index value.

Aspect 10: The method of any of aspects 1 through 9, wherein the threshold quantity of DCI messages comprises a first threshold quantity of DCI messages the UE is capable of processing for downlink communications and a second threshold quantity of DCI messages the UE is capable of processing for uplink communications.

Aspect 11: The method of any of aspects 1 through 10, wherein transmitting the capability message comprises: transmitting, as part of the capability message, respective threshold quantities of DCI messages each associated with respective monitoring configurations.

Aspect 12: The method of aspect 11, wherein the respective monitoring configurations comprise one or more of a slot-based downlink control channel monitoring, a span-based downlink control channel monitoring, a first cross-carrier scheduling scheme associated with a switch from a lower SCS to a higher SCS, and a second cross-carrier scheduling scheme associated with a switch from the higher SCS to the lower SCS.

Aspect 13: The method of any of aspects 1 through 12, wherein the capability message is associated with a band combination, a band, a band of a band combination, a CC of a band of a band combination, or a combination thereof.

Aspect 14: The method of any of aspects 1 through 13, wherein a first TRP is associated with a first CORESET pool index value of the plurality of CORESET pool index values and a second TRP is associated with a second CORESET pool index value of the plurality of CORESET pool index values, and the one or more DCI messages are received via the first TRP, the second TRP, or both.

Aspect 15: The method of any of aspects 1 through 14, wherein the time duration is a slot, a PDCCH span, or a PDCCH monitoring occasion.

Aspect 16: A method for wireless communications, at a network entity, comprising: receiving, from a UE, a capability message indicating a threshold quantity of DCI messages the UE is capable of processing in a time duration for each CC that is associated with a plurality of CORESET pool index values; transmitting a first control message indicating that a CC is configured with the plurality of CORESET pool index values; and transmitting one or more DCI messages associated with the CC based at least in part on the threshold quantity of DCI messages and the CC being configured with the plurality of CORESET pool index values.

Aspect 17: The method of aspect 16, further comprising: transmitting a second control message indicating a control information configuration that enables the UE to process the threshold quantity of DCI messages for each CC that is associated with the plurality of CORESET pool index values, the control information configuration being based at least in part on the capability message, wherein transmitting the one or more DCI messages is based at least in part on transmitting the second control message.

Aspect 18: The method of aspect 17, wherein the control information configuration enables the UE to process DCI messages for a first CC, or a BWP, or both, associated with the plurality of CORESET pool index values.

Aspect 19: The method of aspect 18, wherein the first CC, or the BWP, or both, comprises a scheduling CC including first control information that schedules an uplink transmission or a downlink transmission for a second CC different from the scheduling CC; or the first CC, or the BWP, or both, comprises a scheduled CC including the downlink transmission or the uplink transmission scheduled by second control information received via a third CC different from the scheduled CC.

Aspect 20: The method of any of aspects 17 through 19, wherein the control information configuration enables for the UE to process DCI messages for each CC of a set of CCs that are included in a cell group and associated with the plurality of CORESET pool index values.

Aspect 21: The method of any of aspects 16 through 20, further comprising: receiving, via the capability message, an indication that the threshold quantity of DCI messages is for each of CORESET pool index value of the plurality of CORESET pool index values.

Aspect 22: The method of any of aspects 16 through 20, further comprising: receiving, via the capability message, an indication that the threshold quantity of DCI messages is across the plurality of CORESET pool index values.

Aspect 23: The method of any of aspects 16 through 22, further comprising: receiving, via the capability message, an indication that the threshold quantity of DCI messages is equal to a second threshold quantity of DCI messages the UE is capable of processing for CCs that are associated with a single CORESET pool index value or for CCs that are not associated with a CORESET pool index value, wherein the threshold quantity of DCI messages is for each of CORESET pool index value of the plurality of CORESET pool index values.

Aspect 24: The method of any of aspects 16 through 22, further comprising: receiving, via the capability message, an indication that the threshold quantity of DCI messages is double a second threshold quantity of DCI messages the UE is capable of processing for CCs that are associated with a single CORESET pool index value or for CCs that are not associated with a CORESET pool index value.

Aspect 25: The method of any of aspects 16 through 24, wherein the threshold quantity of DCI messages comprises a first threshold quantity of DCI messages the UE is capable of processing for downlink communications and a second threshold quantity of DCI messages the UE is capable of processing for uplink communications.

Aspect 26: The method of any of aspects 16 through 25, wherein receiving the capability message comprises: receiving, as part of the capability message, respective threshold quantities of DCI messages each associated with respective monitoring configurations.

Aspect 27: The method of aspect 26, wherein the respective monitoring configurations comprise one or more of a slot-based downlink control channel monitoring, a span-based downlink control channel monitoring, a first cross-carrier scheduling scheme associated with a switch from a lower SCS to a higher SCS, and a second cross-carrier scheduling scheme associated with a switch from the higher SCS to the lower SCS.

Aspect 28: The method of any of aspects 16 through 27, wherein the capability message is associated with a band combination, a band, a band of a band combination, a CC of a band of a band combination, or a combination thereof.

Aspect 29: The method of any of aspects 16 through 28, wherein a first TRP of the network entity is associated with a first CORESET pool index value of the plurality of CORESET pool index values and a second TRP of the network entity is associated with a second CORESET pool index value of the plurality of CORESET pool index values, and the one or more DCI messages are transmitted via the first TRP, the second TRP, or both.

Aspect 30: The method of any of aspects 16 through 29, wherein the time duration is a slot, a PDCCH span, or a PDCCH monitoring occasion.

Aspect 31: A UE for wireless communications, comprising one or more memories storing processor-executable code, and one or more processors coupled with the one or more memories and operable to execute the code to cause the UE to perform a method of any of aspects 1 through 15.

Aspect 32: A UE for wireless communications, comprising at least one means for performing a method of any of aspects 1 through 15.

Aspect 33: A non-transitory computer-readable medium storing code for wireless communications, the code comprising instructions executable by one or more processors to perform a method of any of aspects 1 through 15.

Aspect 34: A network entity for wireless communications, comprising one or more memories storing processor-executable code, and one or more processors coupled with the one or more memories and operable to execute the code to cause the network entity to perform a method of any of aspects 16 through 30.

Aspect 35: A network entity for wireless communications, comprising at least one means for performing a method of any of aspects 16 through 30.

Aspect 36: A non-transitory computer-readable medium storing code for wireless communications, the code comprising instructions executable by one or more processors to perform a method of any of aspects 16 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and operable to execute the code to cause the UE to:
transmit a capability message indicating a threshold quantity of downlink control information messages the UE is capable of processing in a time duration for each component carrier that is associated with a plurality of control resource set pool index values;
receive a first control message indicating that a component carrier is configured with the plurality of control resource set pool index values; and
receive one or more downlink control information messages associated with the component carrier based at least in part on the threshold quantity of downlink control information messages and the component carrier being configured with the plurality of control resource set pool index values.

2. The UE of claim 1, wherein the one or more processors are further operable to execute the code to cause the UE to:
receive a second control message indicating a control information configuration that enables the UE to process the threshold quantity of the downlink control information messages for each component carrier that is associated with the plurality of control resource set pool index values, the control information configuration being based at least in part on the capability message, wherein receiving the one or more downlink control information messages is based at least in part on receiving the second control message.

3. The UE of claim 2, wherein the control information configuration enables the UE to process the downlink control information messages for a first component carrier, or a bandwidth part, or both, associated with the plurality of control resource set pool index values.

4. The UE of claim 3, wherein:
the first component carrier, or the bandwidth part, or both, comprises a scheduling component carrier including first control information that schedules an uplink transmission or a downlink transmission for a second component carrier different from the scheduling component carrier; or
the first component carrier, or the bandwidth part, or both, comprises a scheduled component carrier including the downlink transmission or the uplink transmission scheduled by second control information received via a third component carrier different from the scheduled component carrier.

5. The UE of claim 2, wherein the control information configuration enables for the UE to process the downlink control information messages for each component carrier of a set of component carriers that are included in a cell group and associated with the plurality of control resource set pool index values.

6. The UE of claim 1, wherein the one or more processors are further operable to execute the code to cause the UE to:
indicate, via the capability message, that the threshold quantity of the downlink control information messages is for each of control resource set pool index value of the plurality of control resource set pool index values.

7. The UE of claim 1, wherein the one or more processors are further operable to execute the code to cause the UE to:
indicate, via the capability message, that the threshold quantity of the downlink control information messages is across the plurality of control resource set pool index values.

8. The UE of claim 1, wherein the one or more processors are further operable to execute the code to cause the UE to:
indicate, via the capability message, that the threshold quantity of the downlink control information messages is equal to a second threshold quantity of the downlink control information messages the UE is capable of processing for component carriers that are associated with a single control resource set pool index value or for component carriers that are not associated with a control resource set pool index value, wherein the threshold quantity of the downlink control information messages is for each of the control resource set pool index value of the plurality of control resource set pool index values.

9. The UE of claim 1, wherein the one or more processors are further operable to execute the code to cause the UE to:
indicate, via the capability message, that the threshold quantity of the downlink control information messages is double a second threshold quantity of the downlink control information messages the UE is capable of processing for component carriers that are associated with a single control resource set pool index value or for the component carriers that are not associated with a control resource set pool index value.

10. The UE of claim 1, wherein the threshold quantity of the downlink control information messages comprises a first threshold quantity of the downlink control information messages the UE is capable of processing for downlink communications and a second threshold quantity of the downlink control information messages the UE is capable of processing for uplink communications.

11. The UE of claim 1, wherein, to transmit the capability message, the one or more processors are further operable to execute the code to cause the UE to:
transmit, as part of the capability message, respective threshold quantities of the downlink control information messages each associated with respective monitoring configurations.

12. The UE of claim 11, wherein the respective monitoring configurations comprise one or more of a slot-based downlink control channel monitoring, a span-based downlink control channel monitoring, a first cross-carrier scheduling scheme associated with a switch from a lower sub-carrier spacing to a higher sub-carrier spacing, and a second cross-carrier scheduling scheme associated with a switch from the higher sub-carrier spacing to the lower sub-carrier spacing.

13. The UE of claim 1, wherein the capability message is associated with a band combination, a band, a band of a band combination, a component carrier of the band of the band combination, or a combination thereof.

14. The UE of claim 1, wherein:
a first transmission and reception point is associated with a first control resource set pool index value of the plurality of control resource set pool index values and a second transmission and reception point is associated with a second control resource set pool index value of the plurality of control resource set pool index values, and
the one or more downlink control information messages are received via the first transmission and reception point, the second transmission and reception point, or both.

15. The UE of claim 1, wherein the time duration is a slot, a physical downlink control channel span, or a physical downlink control channel monitoring occasion.

16. A network entity, comprising:
one or more memories storing processor-executable code; and
one or more processors coupled with the one or more memories and operable to execute the code to cause the network entity to:
receive, from a user equipment (UE), a capability message indicating a threshold quantity of downlink control information messages the UE is capable of processing in a time duration for each component carrier that is associated with a plurality of control resource set pool index values;
transmit a first control message indicating that a component carrier is configured with the plurality of control resource set pool index values; and
transmit one or more downlink control information messages associated with the component carrier based at least in part on the threshold quantity of downlink control information messages and the component carrier being configured with the plurality of control resource set pool index values.

17. The network entity of claim 16, wherein the one or more processors are further operable to execute the code to cause the network entity to:
transmit a second control message indicating a control information configuration that enables the UE to process the threshold quantity of the downlink control information messages for each component carrier that is associated with the plurality of control resource set pool index values, the control information configuration being based at least in part on the capability message, wherein transmitting the one or more downlink control information messages is based at least in part on transmitting the second control message.

18. The network entity of claim 17, wherein the control information configuration enables the UE to process the downlink control information messages for a first component carrier, or a bandwidth part, or both, associated with the plurality of control resource set pool index values.

19. The network entity of claim 18, wherein:
the first component carrier, or the bandwidth part, or both, comprises a scheduling component carrier including first control information that schedules an uplink transmission or a downlink transmission for a second component carrier different from the scheduling component carrier; or
the first component carrier, or the bandwidth part, or both, comprises a scheduled component carrier including the downlink transmission or the uplink transmission scheduled by second control information received via a third component carrier different from the scheduled component carrier.

20. The network entity of claim 17, wherein the control information configuration enables for the UE to process the downlink control information messages for each component carrier of a set of component carriers that are included in a cell group and associated with the plurality of control resource set pool index values.

21. The network entity of claim 16, wherein the one or more processors are further operable to execute the code to cause the network entity to:
receive, via the capability message, an indication that the threshold quantity of the downlink control information messages is for each of control resource set pool index value of the plurality of control resource set pool index values.

22. The network entity of claim 16, wherein the one or more processors are further operable to execute the code to cause the network entity to:
receive, via the capability message, an indication that the threshold quantity of the downlink control information messages is across the plurality of control resource set pool index values.

23. The network entity of claim 16, wherein the one or more processors are further operable to execute the code to cause the network entity to:
receive, via the capability message, an indication that the threshold quantity of the downlink control information messages is equal to a second threshold quantity of the downlink control information messages the UE is capable of processing for component carriers that are associated with a single control resource set pool index value or for component carriers that are not associated with a control resource set pool index value, wherein the threshold quantity of the downlink control information messages is for each of the control resource set pool index value of the plurality of control resource set pool index values.

24. The network entity of claim 16, wherein the one or more processors are further operable to execute the code to cause the network entity to:
receive, via the capability message, an indication that the threshold quantity of the downlink control information messages is double a second threshold quantity of the downlink control information messages the UE is capable of processing for component carriers that are associated with a single control resource set pool index value or for the component carriers that are not associated with a control resource set pool index value.

25. The network entity of claim 16, wherein the threshold quantity of the downlink control information messages comprises a first threshold quantity of the downlink control information messages the UE is capable of processing for downlink communications and a second threshold quantity of the downlink control information messages the UE is capable of processing for uplink communications.

26. The network entity of claim 16, wherein, to receive the capability message, the one or more processors are further operable to execute the code to cause the network entity to:
receive, as part of the capability message, respective threshold quantities of the downlink control information messages each associated with respective monitoring configurations.

27. The network entity of claim 26, wherein the respective monitoring configurations comprise one or more of a slot-based downlink control channel monitoring, a span-based downlink control channel monitoring, a first cross-carrier scheduling scheme associated with a switch from a lower sub-carrier spacing to a higher sub-carrier spacing, and a second cross-carrier scheduling scheme associated with a switch from the higher sub-carrier spacing to the lower sub-carrier spacing.

28. The network entity of claim 16, wherein the capability message is associated with a band combination, a band, a band of a band combination, a component carrier of the band of the band combination, or a combination thereof.

29. A method for wireless communications, at a user equipment (UE), comprising:
transmitting a capability message indicating a threshold quantity of downlink control information messages the UE is capable of processing in a time duration for each component carrier that is associated with a plurality of control resource set pool index values;
receiving a first control message indicating that a component carrier is configured with the plurality of control resource set pool index values; and
receiving one or more downlink control information messages associated with the component carrier based at least in part on the threshold quantity of downlink control information messages and the component carrier being configured with the plurality of control resource set pool index values.

30. A method for wireless communications, at a network entity, comprising:
receiving, from a user equipment (UE), a capability message indicating a threshold quantity of downlink control information messages the UE is capable of processing in a time duration for each component carrier that is associated with a plurality of control resource set pool index values;
transmitting a first control message indicating that a component carrier is configured with the plurality of control resource set pool index values; and
transmitting one or more downlink control information messages associated with the component carrier based at least in part on the threshold quantity of downlink control information messages and the component carrier being configured with the plurality of control resource set pool index values.
